(19) United States
(12) Patent Application Publication
(10) Pub. No.: US 2026/0311990 A1
(43) Pub. Date: Oct. 8, 2026

(54) METHOD OF SCHEDULING IONS FOR ANALYSIS

(71) Applicants: Thermo Fisher Scientific (Bremen) GmbH, Bremen (DE); Thermo Finnigan LLC, San Jose, CA (US)

(72) Inventors: Hamish Stewart, Bremen (DE); Alexander Makarov, Bremen (DE); Michael W. Senko, Sunnyvale, CA (US); Mikhail V. Ugarov, San Jose, CA (US); Michael Goodwin, Santa Clara, CA (US)

(21) Appl. No.: 19/638,148

(22) Filed: Apr. 3, 2026

Related U.S. Application Data
(60) Provisional application No. 63/782,870, filed on Apr. 3, 2025.

(51) Int. Cl. H01J 49/42; H01J 49/00

(52) U.S. Cl. CPC H01J 49/4215; H01J 49/0031

(57) ABSTRACT

A method of scheduling ions for analysis by a mass analyser over a mass to charge ratio (m/z) range of interest is provided. The method comprises obtaining predicted intensities and associated m/z for the ions across the mass range of interest. The method also comprises inputting ions to an ion scheduling device, outputting the ions from the ion scheduling device to the mass analyser according to the m/z or ion mobility of the ions, and selectively attenuating the ions based on the predicted intensities and associated m/z of the ions.

### CROSS REFERENCE TO RELATED APPLICATION

This patent application claims the benefit of priority to U.S. Provisional Patent Application Ser. No. 63/782,870, filed on Apr. 3, 2025, which is hereby incorporated by reference herein in its entirety.

### FIELD OF THE DISCLOSURE

The present disclosure relates to mass spectrometry. In particular, the present disclosure relates to methods of ion scheduling for mass spectrometry.

### BACKGROUND

U.S. Pat. No. 2,939,952 discloses a tandem mass spectrometer which employs a quadrupole mass filter to isolate target ions prior to fragmentation and further downstream mass analysis. One feature of the quadrupole mass filter is that unselected ions strike the quadrupole rods of the quadrupole mass filter, losing precious analyte ions whilst also contaminating and eventually degrading the electrodes. Depending on the isolation windows employed, the loss of theoretical sensitivity may easily exceed 99%.

One workaround is to accumulate and separate ions in advance (upstream) of the quadrupole, so that the ion m/z delivered to the device approximately matches the range of the isolation window and ion losses are consequently minimized to the accuracy of the pre-separation. Residual losses then become a factor of the resolution of the pre-separation and the quality of the alignment to the quadrupole isolation window.

The method was first described by Hoyes in GB-A-2442638, whereby ions were first loaded into an ion trap. An RF pseudopotential barrier would prevent release of ions of lower m/z, unless overcome by a DC or travelling wave pushing them towards to exit, whereupon they would be released for quadrupole selection/fragmentation etc. Giles in U.S. Pat. No. 6,914,241B and Bateman U.S. Pat. No. 6,838,662 further describe a method of using an opposed travelling wave and non-linear DC gradients to cause separation of ions within a guide. These reach equilibrium positions and may, by adjusting the DC or travelling wave amplitude, then be released in a time dependent manner through a quadrupole, greatly boosting its efficiency. FIG. 1 illustrates ion separation under these two opposing forces, while FIG. 2 shows a schematic diagram of an ion scheduling method using an ion scheduling device and a quadrupole.

There are multiple technologies that may be used to achieve this “ion scheduling” process. Typical methods involve separating ions under the exposure of two different forces, such as DC potential, RF pseudopotential (or travelling wave), or collisional drag with buffer gas. A method of ion scheduling comprising parallel acquisition of ions followed by serial fragmentation is discloses in U.S. Pat. No. 10,665,441. A parallel accumulation and serial fragmentation method from a trapped ion mobility spectrometry (TIMS) device is also disclosed in Meier, F. et al. Parallel Accumulation-Serial Fragmentation (PASEF): Multiplying Sequencing Speed and Sensitivity by Synchronized Scans in a Trapped Ion Mobility Device. Journal of Proteome Research 2015, 12, 5378-5387, U.S. Pat. Nos. 9,891,194B2 and 10,794,861B2). Other implementations include accumulation into multiple traps, either orthogonally across an RF pseudopotential (U.S. Pat. No. 10,199,208B2) or via ion mobility (U.S. Pat. No. 9,607,817B1).

It is also known to utilise travelling waves to propel ions through ion guides. U.S. Pat. No. 7,375,344 discloses the application of a series of out-of-phase RF potentials, while Giles et al, Applications of a travelling wave-based radio-frequency-only stacked ring ion guide, Rapid Commun. Mass Spectrom. 2004; 18:2401-2414, discloses the application of switched DC pulses to successive axial segments of an ion guide to create a potential front that moves down the centre of the guide with time, dragging ions with it.

Mass spectrometers control ion loading to trapping devices by varying ion accumulation time, in a process known as automatic gain control. Ion scheduling devices necessarily block this process by transforming a continuous ion beam into time-varying, concentrated pulses of ions of similar m/z. It is believed that this issue may be resolved by a downstream beam attenuating device, most promisingly by varying the duty cycle of a rapidly pulsed ion optical gating element. U.S. Pat. No. 7,960,690 has demonstrated this effect with 1 kHz switching, where ion packets are expected to emerge with <2 ms pulse width.

Tandem mass spectrometry methods involve the isolation and fragmentation of eluted analyte species, whereby fragment mass spectra are then generated and mass analysed to return structural and quantitative information. These MS/MS, or MS2 spectra are often supported by survey spectra of a wide range of unfragmented precursor ions, termed MS1, MS or Full-MS spectra, that provide information on their accurate m/z and intensity. For Data Independent Acquisition (DIA) methods, this analysis is optional, but for Data Dependent Acquisition (DDA), it is required to generate a list of precursor targets for MS2 analysis. A substantial problem is posed by the dynamic range of the MS1 spectrum. Digested peptide concentration varies by up to 10 orders of magnitude, but the dynamic range of a single shot spectrum in, for example, an orbital trapping mass analyser is limited to 4. Furthermore, the number of ions that may be injected into the orbital trapping mass analyser may be limited by the capacity of the accumulating C-Trap to ~10⁵, and consequently low intensity peptide precursor signals are easily overwhelmed and potential targets for fragmentation missed or poorly quantified.

One important method to improve the dynamic range of the MS1 spectrum is the High Dynamic Range (HDR), or Boxcar method, whereby the wide mass range of the analysis is subdivided into a number of narrower isolation windows, and a separate injection made into the C-Trap for each, with differing fill time dependent on the ion current (Meier et al, Nature Methods, 2018, 15, 440-448). The total ion population is then analysed together, for example in an orbital trapping mass analyser. By this method heavily populated regions are attenuated and sparsely populated mass regions amplified, boosting many relatively weak peaks and greatly improving the effective dynamic range of the spectrum. This comes at the cost of greatly increasing the time required to accumulate ions over multiple fills. Because of the long fill times for low-level windows, and the milliseconds required to switch the quadrupole and ion source voltages, HDR methods quickly impact the rate at which MS2 spectra that may be acquired.

Against this background, the present disclosure provides an improved, or at least commercially relevant alternative, method of ion scheduling for mass analysis.

### SUMMARY

According to a first aspect of the disclosure, a method of scheduling ions for analysis by a mass analyser over a mass to charge ratio (m/z) range of interest is provided. The method comprises:
obtaining predicted intensities and associated m/z for the ions across the mass range of interest;
inputting ions to an ion scheduling device;
outputting the ions from the ion scheduling device to the mass analyser according to the m/z or ion mobility of the ions; and
selectively attenuating the ions based on the predicted intensities and associated m/z of the ions.

The method of the first aspect aims to address the technological challenges associated with the interaction of ion scheduling with fast (e.g. 200-400 Hz) spectral acquisition, fast switching between full MS and MS/MS, and control of the ion population of space charge limited downstream trapping regions (e.g. automatic gain control).

In particular, control of the ion population output from the ion scheduling device may be challenging where there are relatively large variations in the abundance of species within the ion population. The typical operation of an ion scheduling device will amplify the number of ions output to a downstream mass analyser, relative to a typical DIA/DDA method, by a factor between 3 and >>100 depending on the ion scheduling device used. However, many ion species are already very intense and able to saturate downstream analysis without the use of an ion scheduling device. As such, the ion scheduling device itself may easily be overfilled by relatively intense species, which in turn generates unwanted space charge effects. Therefore, the presence of relatively high intensity species within the ion scheduling device may make it more challenging to separate and schedule relatively low abundance species within the ion population using the ion scheduling device. As such, the method of the first aspect aims to improve the dynamic range of the ions output from the ion scheduling device.

As such, the method of the first aspect realises that to improve the amplification of relatively low abundance species of the ion population using the ion scheduling device, it is desirable to selectively attenuate relatively intense species that would otherwise overwhelm the capacity/dynamic range of the ion scheduling device and/or the mass analyser. This must be done in an m/z (or ion mobility) dependent manner, to spare the relatively lower abundance species that the ion scheduling device aims to amplify.

According to the method of the first aspect, prior to analysis of the ions, a prediction of the intensities and associated m/z for the ions across the mass range of interest is obtained. These predicted intensities are used to inform which m/z (ions) should be selectively attenuated in order to reduce the presence of relatively high abundance species from the ions output from the ion scheduling device. According to this disclosure, the selective attenuation of the ions may be performed upstream of the ion scheduling device, within the ion scheduling device, or downstream of the ion scheduling device, prior to analysis by the mass analyser. Further details of these implementations are provided below.

In some embodiments, selectively attenuating the ions based on the predicted intensities and associated m/z of the ions comprises: identifying, from the predicted intensities and associated m/z, a list of m/z of ions having an associated predicted intensity above a predetermined threshold intensity, and selectively attenuating the ions based on the list of m/z. As such, the list of m/z of ions may identify one or more ion species having a predicted intensity above the predetermined threshold intensity which may reduce the dynamic range of the ions output for mass analysis. Accordingly, methods according to this disclosure may selectively attenuate, or even remove, ions species having an excessively high predicted intensity from the ions output the ion scheduling device.

In some embodiments, the ion scheduling device outputs the ions sequentially as a plurality of ion scheduler groups of ions. Each ion scheduler group of ions spans a m/z extraction window such that the plurality of ion scheduler groups cover the m/z range of interest. Alternatively, each ion scheduler group of ions may span an ion mobility extraction window. That is to say, the ion scheduling device may separate the ions into groups according to their m/z or ion mobility. The groups of ions may then be sequentially output from the ion scheduling device based on the m/z or ion mobility of the ions. In some embodiments, ion scheduler groups of ions may be sequentially output in order of increasing m/z or increasing ion mobility. In some embodiments, ion scheduler groups of ions may be sequentially output in order of decreasing m/z or decreasing ion mobility.

In some embodiments, the method of the first aspect may be a method of ion scheduling for a data dependent acquisition (DDA) method. As such, in some embodiments the method may further comprise obtaining a list of target m/z, and scheduling the output of the ions from the ion scheduling device based on the list of target m/z. For example, the DDA method may include obtaining a list of target m/z corresponding to precursor ions, or analyte of ions of interest identified in an earlier mass analysis forming part of a DDA method. The method of ion scheduling according to the first aspect may then output ions, or groups of ions, from the ion scheduling device to the mass analyser based on the list of target m/z. According to the method of the first aspect, relatively high intensity ions, or ion groups of relatively high intensity, may be seclusively attenuated in order to improve the dynamic range of ions corresponding to the list of target m/z.

In some embodiments, the method of the first aspect may be a method of ion scheduling for a data independent acquisition (DIA) method. As such, in some embodiments, the ion scheduler groups of ions output by the ion scheduler may be analysed directly by a mass analyser as part of a DIA methodology. As such, the isolation window of each DIA analysis may be defined by the m/z extraction window of the ion separation device. In some embodiments, the ion scheduler groups of ions may also be mass filtered by a downstream mass filter using a further m/z isolation window, for example a m/z isolation window which is narrower than the m/z extraction window of the ion scheduling device. Where ion mobility is used to separate the ion scheduler groups of ions, the ion separation device may select a subset of ions using a m/z isolation window from the ion scheduler group of ions. As such, in some embodiments, for example in a DIA methodology, the method may comprise mass filtering each ion scheduler group of ions output from the ion scheduling device using a downstream mass filtering device, wherein the mass filtering device outputs a plurality of filtered groups of ions to the mass analyser, each filtered group of ions spanning a m/z isolation window of the mass filtering device. In such embodiments, the isolation window of each DIA analysis may be defined by the m/z isolation window applied by the mass filtering device.

In some embodiments, for example in a DIA methodology, the methodology may require multiple fills of the ion scheduling device in order to resolve each m/z isolation window forming part of the DIA methodology. As such, in some embodiments, a plurality of ion scheduling cycles may be performed, wherein in each ion scheduling cycle ions may be input to the ion scheduling device, and the ion scheduling device outputs the plurality of ion scheduler groups sequentially for each ion scheduling cycle. In particular, for a DIA methodology the mass filtering device may update a m/z range of the mass filtering device for each ion scheduler group of ions output from the ion scheduling device such that the plurality of filtered groups of ions output from the mass filtering device span the m/z range of interest.

In some embodiments, the ions may be selectively attenuated by an upstream mass selection device prior to the input of the ions to the ion scheduling device. By selectively attenuating the ions upstream of the ion scheduling device, space charge effects within the ion scheduling device resulting from relatively abundant ion species may be reduced or eliminated.

In some embodiments, selectively attenuating the ions using the upstream mass filtering device comprises identifying, from the predicted intensities and associated m/z, a first m/z associated with an ion having a predicted intensity above a predetermined threshold intensity. The upstream mass filtering device may then selectively attenuate ions having the first m/z, wherein the mass filtered ions are input to the ion scheduling device. For example, the mass filtering device may apply a notch, or bandpass filter to the ions to mass filter ion having the first m/z. Such a mass filtering device may be provided by e.g. a quadrupole mass filter to which one or more additional RF oscillating voltages may be applied. Each RF oscillating voltage may be selected to attenuate, or entirely remove, ions of a specific m/z by way of resonant ejection of ions from the quadrupole mass filter. By selectively attenuating or removing ions of the first m/z from the ions input to the ion scheduling device, space charge effects within the ion scheduling device may be reduced and/or the dynamic range of the ions output from the ion scheduling device may be improved.

In some embodiments, the method of the first aspect may utilise the upstream mass filtering device in different analysis steps. For example, in a first analysis step, the mass filtering device may mass filter ions having the first m/z and input the (filtered) ions to the ion scheduling device. In a second analysis step, ions having the first m/z may be output to the mass analyser for mass analysis. For example, in the second analysis step, ions having the first m/z may bypass the ion scheduling device, or transit through the ion scheduling device between cycles of the ion scheduling device. That is to say, the relatively intense ions of the first m/z may be analysed separately from the remainder of the ion population and may not undergo an ion scheduling step. By analysing ions of the first m/z separately in a second analysis step, the ion optics (e.g. ion accumulation time in the mass filtering device) may be controlled to account for the relatively higher intensity of the ions of the first m/z (e.g. the accumulation time may be reduced

In some embodiments, selectively attenuating the ions using the upstream mass filtering device based on the predicted intensities and associated m/z of the ions may comprise identifying, from the predicted intensities and associated m/z, a first m/z of an ion having an associated predicted intensity above a predetermined threshold intensity. Based on the first m/z, a first passband m/z range of interest having m/z below the first m/z, and a second passband m/z range of interest having m/z above the first m/z may be identified. Ions within the first passband m/z range of interest and ions within the second passband m/z range of interest may then be analysed in separate ion scheduling cycles of the ion scheduling device. For example, in a first analysis step, the upstream mass filtering device mass may provide ions within the first passband m/z range of interest to the ion scheduling device. In a second analysis step, the mass filtering device may provide ions within the second passband m/z range of interest to the ion scheduling device. As such, in some embodiments, the m/z range of interest may be split into two (or more) passband m/z ranges of interest. In some embodiments, one or more of the first analysis step and the second analysis step may each comprise a plurality of ion scheduling cycles. Ions within each passband may have a predicted intensity below the predetermined threshold intensity. By dividing the relatively low intensity ions between two or more passbands, the ion scheduling device may avoid performing an ion scheduling cycle including ions of a relatively high intensity (e.g. ions of the first m/z) along with ions of a relatively low intensity, thereby improving the dynamic range of the ions output from the ion scheduling device.

In some embodiments, a third analysis step may also be provided in which ions having the first m/z are provided to the mass analyser for mass analysis. For example, in the third analysis step, ions having the first m/z may bypass the ion scheduling device, or transit through the ion scheduling device between cycles of the ion scheduling device. That is to say, the relatively intense ions of the first m/z may be analysed separately from the remainder of the ion population and may not undergo an ion scheduling step. By analysing ions of the first m/z separately in a third analysis step, the ion optics (e.g. ion accumulation time in the mass filtering device) may be controlled to account for the relatively higher intensity of the ions of the first m/z (e.g. the accumulation time may be reduced).

In some embodiments, the selective attenuation of the ions may be performed using the ion scheduling device. In some embodiments, an ion scheduling device comprising a plurality of ion traps may be used to selectively attenuate the ions. For example, the ion scheduling device may comprise a plurality of ion traps, wherein each ion trap has an associated m/z acceptance window. The plurality of m/z acceptance windows may span the m/z range of interest. In some embodiments, the m/z acceptance windows of adjacent ion traps may overlap such that some ions may be accepted into each of two adjacent ion traps (i.e. ions of a m/z within both acceptance windows may be split between two adjacent ion traps). The ion scheduling device may also comprise a plurality of ion gates. Each ion gate may be associated with a respective ion trap. Each ion gate may control the admission of ions within the m/z acceptance window to the associated ion trap. As such, each ion gate may be operated independently of the other ion gates. As the m/z acceptance windows of the ion traps span the m/z range of interest, the presence of a relatively high intensity precursor ion of having e.g. a m/z M₁ may only affect one trap (or possibly two ion traps having overlapping m/z acceptance windows), such that the accumulation of ions in the other traps are not affected by the relatively high intensity precursor ions. Effectively, once the relatively high intensity precursor ions M₁ fill the associated ion trap, the precursor ions M₁ may be attenuated while the other ion traps continue to accumulate ions. Accordingly, the dynamic range of the ions output by the ion scheduling device may be improved. As such, in some embodiments, each ion gate may be controlled independently in order to control the number of ions accepted into the associated ion trap, or the duration (accumulation time) each ion trap accumulates ions for.

For example, selectively attenuating the ions may comprise determining, for each ion gate, an ion accumulation time for ions within the m/z acceptance window of the associated ion trap based on the predicted intensities and associated m/z of the ions. As such, where it is predicted that ions within a m/z acceptance window will have a relatively high intensity, an accumulation time of the associated ion gate may be relatively short. Where it is predicted that ions falling within a m/z acceptance window will have a relatively low intensity, the accumulation time may be increased in duration. As such, in some embodiments, each of the plurality of ion gates may selectively attenuate ions within the m/z acceptance window of the associated ion trap based on the predicted intensities and associated m/z of the ions. For example, each of the plurality of ion gates may selectively control an accumulation time for an associated ion trap in order to selectively attenuate ions within the associated m/z acceptance window.

In some embodiments, the ion scheduling device may comprise a single ion trap, rather than a plurality of ion traps. For example, a single ion trap ion scheduling device may schedule ions such that ions are distributed (scheduled) along the ion trap according to their m/z. In some embodiments, the ion scheduling device may comprise an attenuation electrode associated with a region of the ion scheduling device, the attenuation electrode configured to attenuate or remove ions from the ion scheduling device when supplied with an ion removal voltage. In some embodiments, selectively attenuating the ions comprises selectively supplying the attenuation electrode with the ion removal voltage in order to selectively attenuate ions based on their predicted intensities and associated m/z. As such, the ion scheduling device may selectively attenuate or remove ions as they pass through the region of the ion scheduling device associated with the attenuation electrode. As the ions may be distributed (scheduled) within the ion scheduling device according to their m/z, the attenuation electrode may be operated selectively in order to only attenuate ions of specified m/z (e.g. m/z of ions expected to be present at a relatively high intensity).

In some embodiments, the ion scheduling device outputs the ions sequentially as a plurality of ion scheduler groups, each ions scheduler group spanning a m/z extraction window such that the plurality of ion scheduler groups cover the m/z range of interest. When supplied with the ion removal voltage, the attenuation electrode selectively attenuates or removes an ion schedule group of ions present in the region of the ion scheduling device. So, as the plurality of ion scheduler groups of ions move through the ion scheduling device, some, or all of the ion scheduler groups of ions may pass via the region associated with the attenuation electrode, allowing the attenuation electrode to selectively attenuate the ion scheduler groups is sequence.

In some embodiments, the ion scheduling device may comprise a plurality of attenuation electrodes. The plurality of attenuation electrodes may be distributed in the ion scheduling device, each attenuation electrode associated with a different region of the ion scheduling device. When supplied with an ion removal voltage, each attenuation electrode may selectively attenuate or remove a different ion scheduler group of ions present in the ion scheduling device. As such, in some embodiments, two or more ion scheduler groups of ions may be selectively attenuated in parallel by the ion scheduling device. Parallel attenuation of ions may reduce the number of ion attenuation steps to be performed by the ion scheduling device such that the throughput of the ion scheduling device may be improved, relative to sequential attenuation of ion scheduler groups.

In some embodiments, the (partial) attenuation of an ion scheduler group may be provided for using a multiple step methodology for filling the ion scheduling device. For example, in a first fill step ions may be input to the ion scheduling device and trapped in the ion scheduling device. the ions may then be separated into a plurality of ion scheduler groups. As part of the first fill step, an ion removal voltage may be supplied to an attenuation electrode (or to one or more attenuation electrodes for a parallel process) to selectively attenuate or remove an ion schedule group from the ion scheduling device. In a second fill step, further ions may input to the ion scheduling device and separated into the plurality of ion scheduler groups of ions from the first fill step in which the ion removal voltage is not applied to the attenuation electrode. As such, the second fill step may fill (or only partially fill) an ion scheduler group which was attenuated as part of the first fill step. Ions from the first and second fill steps may then be output from the ion scheduling device according to their m/z simultaneously. In other embodiments, three or more fill steps may also be provided before ions are output from the ion scheduling device.

In some embodiments, ions may also be attenuated after they are output from the ion scheduling device. Post-ion scheduling attenuation of ions may be combined with any of the other techniques for attenuating ions discussed herein (i.e. attenuation of ions as part of the ion scheduling device, and/or attenuation of ions prior to the ion scheduling device).

For example, in some embodiments the method may comprise ions being output to the mass analyser from the ion scheduling device via an attenuating ion gate. In some embodiments, the attenuating ion gate may selectively attenuate the ions based on the predicted intensities and associated m/z of the ions. For example, the ion scheduling device may output ions as a plurality of ion scheduler groups, each ions scheduler group spanning a m/z extraction window. The attenuating ion gate may selectively attenuate an ion scheduler group of ions where a m/z of an ion having a relatively high predicted intensity falls within the m/z extraction window of the ion scheduler group. Accordingly, the dynamic range of the output ions may be improved by selectively attenuating relatively high intensity precursor ions.

In some embodiments, selective attenuation of the ions utilises a priori knowledge of the m/z and/or intensities of the ions input to the ion scheduling device. Such knowledge may, in some embodiments be obtained by performing one or more mass analyses of the ions across the mass range of interest. As such, in some embodiments obtaining predicted intensities and associated m/z for the ions across mass range of interest may comprise determining the predicted intensity and the associated m/z for the ions based on a previous mass analysis performed by the mass analyser. For example, a previous mass analysis may be a mass analysis of the ions across the m/z range of interest (e.g. an MS1 analysis) which was performed at an earlier point in time. In some embodiments, the mass analysis (e.g. an MS1 analysis) may have been performed on a related set of ions at an earlier time period not forming part of the current mass spectrometry experiment. In some embodiments, the previous mass analysis may be a pre-analysis, or survey analysis performed by the mass analyser (e.g. an AGC analysis). As such, the pre-analysis may be performed as part of the current mass spectrometry experiment.

In some embodiments, in particular for ion scheduling devices that separate ions according to their ion mobility, the pre-analysis or survey analysis performed may comprise an ion mobility analysis of the ions. For example, an ion mobility pre-analysis or survey analysis may be performed using an ion scheduling cycle of the ion scheduling device, with the output ions being measured using a mass analyser or an ion mobility analyser (where the instrument includes an ion mobility analyser).

It will be appreciated that the method according to the first aspect may be utilised with a variety of ion scheduling devices. For example, in some embodiments, the ion scheduling device may comprise an ion accumulation region in which ions are accumulated, and an ion separation region in which ions from the ion accumulation region are separated according to their m/z. As such, in some embodiments, ions may move from the ion accumulation region to the ion separation region as they are separated. Separated ions may then move from the ion separation region to exit the ion scheduling device in sequence according to their m/z. In some embodiments, one or more attenuation electrodes may be provided within the ion separation region for the selective attenuation of ions within the ion scheduling device.

In some embodiments, the ion scheduling device may also provide a functionality to avoid separating certain groups of ions. For example, in some embodiments the ion scheduling device may comprise an ion separation path along which ions are separated according to their m/z, a bypass path along which ions are not separated according to their m/z, and a path selection region which selects whether ions travel along the ion separation path or the bypass path. By providing a bypass region, the ion scheduling device may allow (unscheduled) ions to bypass ion scheduling device in parallel with performing an ion scheduling process. As such, the bypass region may allow unscheduled ions to be output to the mass analyser while an ion scheduling process is being performed in order to improve the throughput of the mass analyser. For example, groups of unscheduled ions may be output, or interleaved between ion scheduler groups of ions for further analysis. This may allow for various analyses using unscheduled ions (e.g. pre-analysis scans, survey scans, single ion monitoring scans and the like) to be performed prior to, during, or after, the method of the first aspect.

In some embodiments, the ion scheduling device may comprise a plurality of ion traps. Each ion trap may have an associated m/z acceptance window, wherein the plurality m/z acceptance windows spanning the m/z range of interest. For example, each acceptance window may have a m/z range of at least: 50 m/z, 100 m/z, 150 m/z, or 200 m/z. Thus, a plurality of ion traps may be provided which together accept ions across the m/z range of interest, without the ion scheduling device being excessively large and/or inefficient to manufacture. Each acceptance window may have a m/z range of no greater than: 500 m/z, 400 m/z, 300 m/z, 250 m/z or 200 m/z such that ions are separated into a plurality of ion scheduler groups of distinct m/z spanning the m/z range of interest. In some embodiments, the plurality of ion traps may output ions in sequence such that the ion scheduling device outputs ions to the mass analyser according to the m/z of the ions.

According to a second aspect of the disclosure, a controller for scheduling ions for analysis over a m/z range of interest by a mass analyser is provided. The controller is configured to:
obtain predicted intensities and associated m/z for the ions across the mass range of interest;
cause the ions to be input to an ion scheduling device;
cause the ions to be output from the ion scheduling device to the mass analyser according to the m/z of the ions; and
cause the ions to be selectively attenuated based on the predicted intensities and associated m/z of the ions.

As such, it will be appreciated that the controller may be configured to cause an ion scheduling device and mass analyser to perform the method of the first aspect. Any optional features and associated advantages of the first aspect also apply to the controller of the second aspect.

According to a third aspect of the disclosure, a mass spectrometry system for analysis ions across a m/z range of interest is provided. The mass spectrometry system may comprise an ion scheduling device configured to receive ions and to output ions to the spectrometry system. The mass spectrometry system may be configured to perform the method of the first aspect. For example, the mass spectrometry system may comprise a mass analyser, an ion scheduling device configured to receive ions and to output ions to the mass analyser, and a controller according to the second aspect of the disclosure.

According to a fourth aspect of the disclosure, computer program comprising instructions to cause a mass spectrometry system of the third aspect to execute the steps of the method of the first aspect is provided. As such, it will be appreciated that the computer program of the fourth aspect may incorporate any of the optional features, and associated advantages, of the first, second, or third aspects discussed above.

According to a fifth aspect of the disclosure, a computer-readable medium having stored thereon the computer program of the fourth aspect is provided. As such, it will be appreciated that the computer-readable medium of the fifth aspect may incorporate any of the optional features, and associated advantages, of the first, second, third, or fourth aspects discussed above.

As will be appreciated from the above, aspects of this disclosure provide for the selective attenuation of ions, including prior to entering an ion scheduling device and/or after exiting an ion scheduling device. According to a sixth aspect of the disclosure, selective attenuation of the ions may be provided using an attenuating ion gate for a mass spectrometry system. The attenuating ion gate comprises a first ion lens defining a first aperture, a second ion lens defining a second aperture, and first and second deflector electrodes. The second ion lens is spaced apart from the first ion lens, and the first and second apertures are aligned in an axial direction of the attenuating ion gate to define an ion channel between the first and second apertures. The first and second deflector electrodes are provided on opposing sides of the ion channel between the first ion lens and the second ion lens. The first and second deflector electrodes are configured to receive a variable alternating deflector voltage across the first and second electrodes in order to variably attenuate ions passing through the attenuating ion gate.

The attenuating ion gate of the sixth aspect may provide for the selective attenuation of ion packets (or ion scheduler groups of ions) generated for example by an ion scheduling device according to this disclosure. Conventionally, an ion gate may operate in a binary manner (i.e. fully open or fully closed). As such, attenuating a portion of an ion packet may involve opening (or closing) the ion gate while the ion packet transits the ion gate, such that only a portion of the ions transit the ion gate. The control of such an ion gate requires carefully calibration of the timings of the opening/closing voltages applied in order to provide the desired attenuation level (e.g. 50% of an ion packet transiting the ion gate). In particular, some ion gates may take up to 50 μs for the applied voltages to establish the ion gate as fully open and/or fully closed. So, the selective attenuation of ion groups of relatively short duration pulse widths (e.g. <2 ms pulse width) may require further calibration.

The attenuating ion gate of the sixth aspect provides first and second deflector electrodes to which a variable alternating deflector voltage may be applied. The variable AC deflection voltage may be applied by a voltage supply forming part of the attenuating ion gate or provided as part of the mass spectrometry system. In some embodiments, the voltage supply may be configured to apply a variable frequency, variable amplitude AC deflection voltage to the first deflector electrode and an opposing variable frequency, variable amplitude AC deflection voltage to the second deflector electrode. By controlling the passage of ions by means of a variable alternating deflector voltage amplitude applied to the entire ion group as it transits the ion gate, the calibration of the attenuating ion gate, and the subsequent control of the attenuating ion gate may be simplified relative to a binary on/off gate.

In some embodiments, the AC deflection voltage may have a frequency corresponding to a time period which is greater than a pulse width of the incoming ion packet. For example, for an ion scheduler group of ions having a pulse width of about 2 ms, the AC deflection voltage may have a frequency of at least 500 Hz. Preferably, the AC deflection voltage time period may be at least 10 times greater than the pulse width of the ion scheduler group of ions (e.g. at least 5 kHz for a pulse width of 2 ms). Accordingly, the AC deflection voltage may oscillate a plurality of times relative to the duration (pulse width) of the ion scheduler group of ions as the group transits the attenuating ion gate. In turn, this allows the AC deflection voltage to more reliably/accurately selectively attenuate the ion group of ions.

In some embodiments, the amplitude of the alternating deflector voltage may be varied in order to cause ions to be selectively attenuated by the attenuating ion gate. For example, in some embodiments a first alternating deflector voltage amplitude may be used for the first and second deflector electrodes. The first alternating deflector voltage amplitude may be relatively low (but greater than 0 V), such that the first alternating deflector voltage does not substantially perturb the ions as they transit through the attenuating ion gate. For example, in some embodiments, a first alternating deflector voltage amplitude of no greater than: about 10 V, or about 5 V, may allow about 100% of ions to transit the attenuating ion gate. Where attenuation of ions is desired, a second alternating deflector voltage amplitude may be applied, wherein the second alternating deflector voltage amplitude is greater than the first alternating deflector voltage amplitude. Using a known relationship (e.g. determined by suitable calibration measurements) between the second alternating deflector voltage amplitude and the amount of attenuation of the ions, the attenuating ion gate may control the transit of ions from 100% of ions to 0% of ions of an ion packet (ion scheduler group of ions) with improved resolution. For example, in some embodiments, a second alternating deflector voltage of at least 25 V may cause 0% of ions to be transit the attenuating ion gate. As such, the voltage supply may be configured to vary the amplitude of the alternating deflector voltage from no greater than 10 V to at least 25 V in order to control the attenuation of ions passing through the ion gate.

In some embodiments, a frequency of the alternating deflector voltage may be varied in order to control the attenuation of the ions. For example, in some embodiments a first alternating deflector voltage frequency may be used for the first and second deflector electrodes. The first alternating deflector voltage frequency may be relatively low (but greater than 0 Hz), such that the first alternating deflector voltage does not substantially perturb the ions as they transit through the attenuating ion gate. For example, in some embodiments, a first alternating deflector voltage frequency of no greater than: about 100 kHz, about 50 kHz, about 20 kHz, or about 10 kHz may allow about 100% of ions to transit the attenuating ion gate. Where attenuation of ions is desired, a second alternating deflector voltage frequency may be applied, wherein the second alternating deflector voltage frequency is greater than the first alternating deflector voltage frequency. Using a known relationship (e.g. determined by suitable calibration measurements) between the second alternating deflector voltage frequency and the amount of attenuation of the ions, the attenuating ion gate may control the transit of ions from 100% of ions to 0% of ions of an ion packet (ion scheduler group of ions) with improved resolution. For example, in some embodiments the voltage supply may be configured to vary the frequency of the alternating deflector voltage from no greater than 100 kHz to at least 1000 kHz in order to control the attenuation of ions passing through the ion gate.

In some embodiments, it will be appreciated that both the amplitude and frequency of the alternating deflector voltage may be varied in order to control the attenuation of ions transiting the attenuating ion gate.

In some embodiments, the attenuating ion gate may further comprise a shield electrode defining a shield aperture, wherein the shield electrode may be provided between the first and second deflector electrodes and the second ion lens. The shield aperture may be aligned with the ion channel. The shield electrode may be provided to shield the alternating deflector voltages applied to the first and second deflector electrodes from a voltage applied to the second ion lens and other downstream ion optics devices.

In some embodiments, a variable DC potential (e.g. a deflection voltage or 0 V) may also be applied to one or more deflector electrodes in order to add in additional binary open/closed control of the attenuating ion gate. In some embodiments, the DC potential may be applied to deflector electrodes separate from the first and second deflector electrodes. For example, the attenuating ion gate may comprise a third deflector electrode, the third deflector electrode being provided between the first and second deflector electrodes and the first ion lens, or between the first and second deflector electrodes and the second ion lens. The third deflector electrode may be configured to selectively receive a DC deflection voltage configured to prevent ions transiting the attenuating ion gate.

In some embodiments, one or more shield electrodes may also be provided between the first and second electrodes and the third electrode. As such a shield electrode defining a shield aperture, wherein the shield electrode is provided between the first and second deflector electrodes and the third deflector electrode may be provided.

In some embodiments, each of the first and second ion lenses may be generally plate-shaped structure, each plate-shaped structure defining a respective aperture through a thickness of the plate-shaped structure. Each of the first and second apertures may be generally circular or elliptical. A DC voltage may be applied to each of the first and second ion lenses. The DC voltage may cause ions to be accelerated through the attenuating ion gate (e.g. a negative voltage for positively charged ions).

In particular, in some embodiments, the second ion lens may comprise a plate, wherein the plate defines the second aperture through a thickness of the plate. In some embodiments, an edge of the plate may define the second aperture may be extruded towards the first ion aperture to define a skimming region of the second ion lens surrounding the second ion aperture. As ions deflected by the first and second deflector electrodes may be directed towards the edges of the second aperture. Thus, the skimming region may allow the second ion lens to direct ions away from contacting an internal surface of the second aperture. This in turn may reduce wear/contamination of the second ion lens, leading to an improved lifetime of the second aperture.

### BRIEF DESCRIPTION OF THE FIGURES

Embodiments of the disclosure will now be described with reference to the following non-limiting figures in which:

FIG. 1 is a schematic diagram showing the separation of different m/z ions along an ion guide by opposing an axial pseudopotential force with a variable DC force;

FIG. 2 is a schematic diagram of an ion scheduling method, whereby ions of three different m/z values are accumulated and released in line with resolving quadrupole isolation window;

FIG. 3A shows a schematic diagram of an ion scheduling device according to this disclosure including a single ion trap ion scheduling device;

FIG. 3B) shows a schematic diagram of an ion scheduling device according to this disclosure comprising a bypass;

FIG. 3C) shows a schematic diagram of a multi-ion trap ion scheduling device according to this disclosure;

FIG. 4 is a schematic diagram of a mass spectrometry system comprising an orbital trapping mass analyser and an MRTOF mass analyser according to an embodiment of the disclosure;

FIG. 5 is a schematic diagram of a linear ion scheduling device and an attenuating ion gate;

FIG. 6 is a flow chart for a method of operating an ion scheduling device, showing times where ions may be selectively attenuated;

FIG. 7 is a graph showing an order of analyte m/z targets in a basic DIA cycle incorporating multiple cycles of the ion scheduling device;

FIG. 8 is schematic diagram showing a low-resolution mass filter placed in advance of the ion scheduling device to limit the incoming mass range and remove excess ions;

FIG. 9 is a schematic diagram of a multi-trap ion scheduling device with each trap's accumulation time controlled by an individual ion gate;

FIG. 10 shows a schematic diagram of an implementation of attenuation electrodes into a stack of RF electrodes, that may be activated to remove ions in the m/z range associated with their position;

FIG. 11 shows a schematic diagram of a regional purge method whereby guard electrodes are de-activated or set to an attractive potential, allowing unwanted m/z regions to spill out of the device;

FIG. 12 shows a schematic diagram of a cross section of an attenuating ion gate according to an embodiment of the disclosure;

FIG. 13 shows a schematic diagram of an isometric view of an attenuating ion gate according to an embodiment of the disclosure;

FIG. 14A shows the results of a simulations of different alternative deflector voltages (variable amplitude and variable frequency) on the transmission of ions generated over a 1 ms period;

FIG. 14B shows the impact of varying frequency for a 25 V amplitude alternating deflector voltage;

FIG. 14C shows the dependency of transmission on m/z of the ions for the simulation results of FIGS. 14A and 14B;

FIG. 15 shows a schematic diagram of a cross section of an attenuating ion gate according to a further embodiment of the disclosure; and

FIG. 16 shows a schematic diagram of a cross section of a second aperture of an attenuating ion gate according to an embodiment of the disclosure.

### DETAILED DESCRIPTION

Throughout this disclosure, the term “intensity”, when used in reference to a collection of ions, refers to a quantity of, or a flux of, ions of a particular type that are generated from a common sample and that are detected by a mass spectrometer operated under controlled conditions (e.g., without limitation, during a certain common measurement time period). In practical terms, the ion intensity is the magnitude of a signal that corresponds to the quantity of or flux of ions of the particular ion type that are/is detected. In many instances, the phrase “particular type”, as used above, may refer to ions comprising a particular mass-to-charge (m/z) ratio or a particular restricted range of m/z ratios. In many instances, the measured m/z ratio may be correlated with or indicative of the presence of a particular ion composition (i.e., an ion species).

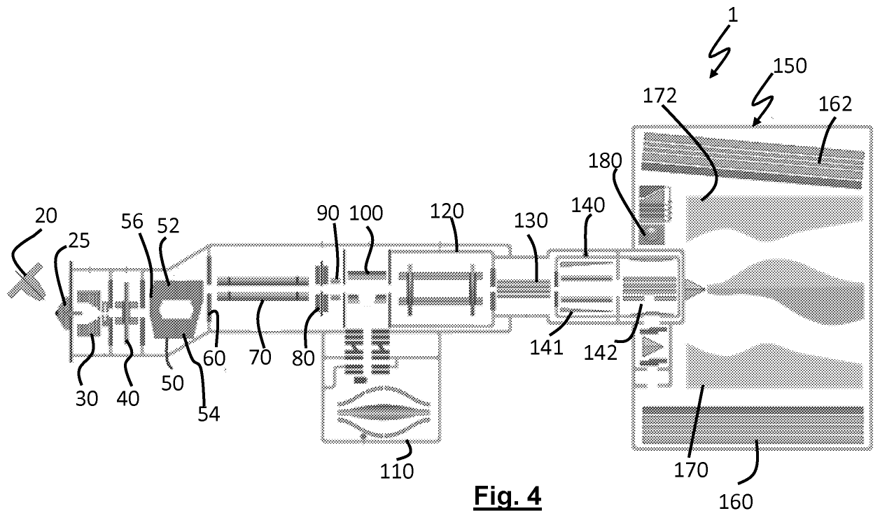

According to this disclosure a method of ion scheduling is provided. A method of ion scheduling according to an embodiment of this disclosure may be performed by a mass spectrometry system 1. A schematic diagram of a mass spectrometry system 1 according to this disclosure is shown in FIG. 4. The mass spectrometry system 1 may be used to analyse a sample supplied from a chromatographic apparatus such as a liquid chromatography (LC) column (not shown in FIG. 4). One such example of an LC column is the Thermo Fisher Scientific, Inc ProSwift (RTM) monolithic column which offers high performance liquid chromatography (HPLC) through the forcing of the sample carried in a mobile phase under high pressure through a stationary phase of irregularly or spherically shaped particles constituting the stationary phase. In the HPLC column, sample molecules elute at different rates according to their degree of interaction with the stationary phase. In other embodiments, sample molecules may be supplied by any other suitable means, for example a gas chromatography column or other sample delivery methods known to the skilled person.

The sample molecules may be ionized using an ion source to generate precursor ions. In the embodiment of FIG. 4, the ion source is an electrospray ionization source (ESI source) 20 which is at atmospheric pressure.

Precursor ions generated by the ESI source 20 may then enter a vacuum chamber of the mass spectrometry system 1 and are directed by a capillary 25 into an RF-only lens 30. The precursor ions are focused by the RF-only lens 30 into an injection flatapole 40 which injects the precursor ions into an ion scheduling device 50. In some embodiments, a pre-filter 45 (not shown in FIG. 4) may be placed upstream of the ion scheduling device 50 in order to selectively attenuate the ions.

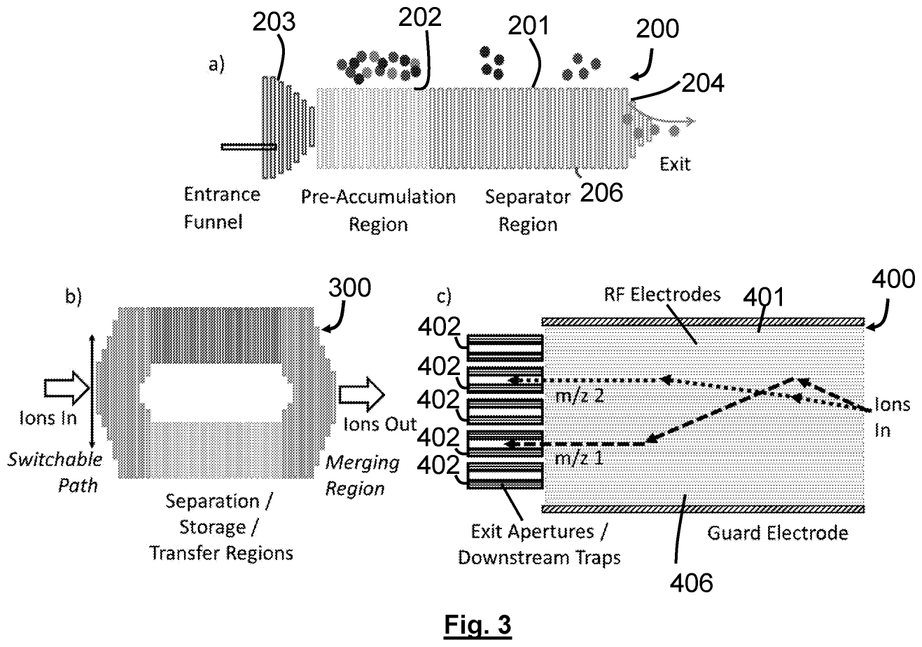

The ion scheduling device 50 shown in FIG. 4 comprises an ion separation path 52 along which ions are separated according to their m/z or ion mobility, and a bypass path 54 along which ions are not separated according to their m/z or ion mobility. The ion scheduling device 50 also comprises a path selection region 56 which selects whether ions travel along the ion separation path 52 or the bypass path 54. As such, the ion scheduling device 50 shown in FIG. 4 is an ion scheduling device comprising a bypass 300, for example as further shown in FIG. 3B). It will be appreciated that the ion scheduling devices 200, 400 of FIGS. 3A) and 3C) may also be used as the ion scheduling device 50 for the mass spectrometry system 1 as further described below. Further details of ion scheduling devices 50 according to this disclosure are discussed in more detail below.

An ion attenuation device 60 may be located at the distal end of the ion scheduling device 50. The ion attenuation device 60 may be configured to control the passage of the precursor ions from the ion scheduling device 50 into a downstream mass selector in the form of a quadrupole mass filter 70. Alternatively, the ion attenuating device 60 may be replaced by a static lens (not shown in FIG. 4) which may be configured to direct ions from the ion scheduling device 50 to the quadrupole mass filter 70 without any intentional attenuation of the ions.

The quadrupole mass filter 70 is typically but not necessarily segmented and serves as a band pass filter, allowing passage of a selected mass number or limited mass range whilst excluding precursor ions of other m/z. The quadrupole mass filter 70 can also be operated in an RF-only mode in which it is not mass selective, i.e. it transmits substantially all m/z precursor ions. For example, the quadrupole mass filter 70 may be controlled by a controller (not shown in FIG. 4) to select a m/z range of precursor ions which are allowed to pass, whilst the other ions in the precursor ion stream outside the m/z range are filtered out (not allowed to pass). For example, the quadrupole mass filter 70 may filter the precursor ions based on the m/z range of interest.

Although a quadrupole mass filter 70 is shown in FIG. 4, the skilled person will appreciate that other types of mass selection devices may also be suitable for selecting precursor ions within the mass range of interest. Furthermore, in some embodiments, more than one ion selection or mass selection device may be provided. For example, a further mass selection device may be provided downstream of an ion routing multipole 120. In this way, MS³ or MSⁿ scans can be performed if desired (typically using the time of flight (TOF) mass analyser 150 for mass analysis).

The mass spectrometry system 1 may be operated in various modes of operation in order to perform analysis of the precursor ions in the MS1 domain and/or the MS2 domain. In a first mode of operation, the precursor ions may be analysed in the MS1 domain using a first mass analyser (for example, as shown an orbital trapping mass analyser 110). As such, according to this disclosure, in a first mode of operation an MS1 analysis is performed using the orbital trapping mass analyser 110.

In the first mode of operation, precursor ions may exit the quadrupole mass filter 70 through an attenuating ion gate 80 and a transfer multipole 90 into a first ion trap 100 (curved trap, or C-trap). The first ion trap 100 has longitudinally extending electrodes which are supplied with RF voltages and end caps that to which DC voltages are supplied. The result is a potential well that extends along the longitudinal axis of the first ion trap 100. In a first mode of operation, ions may be captured and cooled in the first ion trap 100 or transferred to on to the ion routing multipole 120, where the ions are cooled in the ion routing multipole 120. The movement of the ions may be controlled by DC end cap voltages applied to the first ion trap 100. The injection time (IT) of the ions into the first ion trap 100 (or the ion routing multipole 120) determines the number of precursor ions (ion population) that is available for subsequent analysis. From the first ion trap 100, or from the ion routing multipole 120, precursor ions may be directed to different parts of the mass spectrometry system 1, depending on the analysis to be performed.

Where precursor ions are to be analysed by the orbital trapping mass analyser 110 (first mass analyser), if ions are cooled in the ion routing multiple 120, the ions may subsequently be transferred back to the first ion trap 100 for analysis by the Orbital trapping mass analyser 110. The precursor ions may then be ejected orthogonally from the first ion trap 100 towards the orbital trapping mass analyser 110. As shown in FIG. 4, the orbital trapping mass analyser 110 may be an Orbitrap™ mass analyser sold by Thermo Fisher Scientific, Inc. The orbital trapping mass analyser 110 has an off-centre injection aperture and the precursor ions are injected into the orbital trapping mass analyser 110 as coherent packets, through the off-centre injection aperture. Precursor ions are then trapped within the orbital trapping mass analyser 110 by a hyperlogarithmic electric field and undergo back and forth motion in a longitudinal direction whilst orbiting around the inner electrode.

The axial component of the movement of the ion packets in the orbital trapping mass analyser 110 is (more or less) defined as simple harmonic motion, with the angular frequency in the z direction being related to the square root of the mass to charge ratio of a given ion species. Thus, over time, precursor ions separate in accordance with their mass to charge ratio.

Precursor ions in the orbital trapping mass analyser 110 are detected by use of an image current detector comprising barrel shaped detection electrodes 111. The image current detector produces a “transient” in the time domain containing information on all of the ion species as they pass the image current detector. The transient is then subjected to a Fast Fourier Transform (FFT) resulting in a series of peaks in the frequency domain. From these peaks, a mass spectrum, representing abundance/ion intensity versus m/z, can be produced.

In the configuration described above, the precursor ions within the mass range of interest (selected by the quadrupole mass filter 70) are analysed by the orbital trapping mass analyser 110 without fragmentation. The resulting mass spectrum is denoted MS1.

Although an orbital trapping mass analyser 110 is shown in FIG. 4, it will be appreciated that other mass analysers may be employed as the first mass analyser according to embodiments of this disclosure. For example, a Fourier Transform Ion Cyclotron Resonance (FTICR) mass analyser may be utilised as first mass analyser to analyse the precursor ions in the MS1 domain. Mass analysers, such as the orbital trapping mass analyser and Ion Cyclotron Resonance mass analyser, may also be used in the invention even where types of signal processing other than Fourier transformation are used to obtain mass spectral information from the transient signal (see for example WO 2013/171313, Thermo Fisher Scientific). In some embodiments, a TOF mass analyser may also be used in place of the orbital trapping mass analyser 110 to analyse the precursor ions in the MS1 domain.

In a second mode of operation of the mass spectrometry system 1, precursor ions may be analysed by the TOF mass analyser 150 (second mass analyser) in the MS1 domain (an MS1 analysis performed by TOF mass analyser 150). The precursor ions to be analysed by the second mass analyser may be mass filtered by the quadrupole mass filter 70. As such, the precursor ions may be filtered to include precursor ions from the m/z range of interest, or from a m/z subrange of interest.

In order for the TOF mass analyser 150 to analyse precursor ions, precursor ions may pass from the quadrupole exit lens/split lens arrangement 80 and first transfer multipole 90 into the first ion trap 100 and continue their path through the first ion trap 100 and into the ion routing multipole 120. As such, the first ion trap 100 may effectively be operated as an ion guide in the second mode of operation. Alternatively, the precursor ions may be cooled in the first ion trap 100 and may subsequently be ejected from the first ion trap 100 in an axial direction into the ion routing multipole 120. The precursor ions may then continue through the ion routing multipole 120 and be ejected from the ion routing multipole 120 at the opposing axial end to the first ion trap 100. As such, the ion routing multipole 120 may also effectively be operated as an ion guide in the second mode of operation.

The ejected precursor ions pass into an ion guide 130. The ion guide 130 is configured to guide the precursor ions from the ion routing multipole 120 into an ion processor 140. The ion processor 140 is configured to process ions into an ion packet suitable for injection into the TOF mass analyser 150. The ion processor 140 may comprise an RF voltage-controlled third ion trap containing a buffer gas. For example, a suitable buffer gas is nitrogen at a pressure in the range 5×10⁻⁴ mBar to 1×10⁻² mBar. The ion processor may optionally be used to induce fragmentation of the ions for analysis in the MS2 domain. For analysis in the MS1 domain, fragmentation of the ions is not desired, so ions may be transferred from the fragmentation chamber 141 of the ion processor to the extraction trap 142 of the ion processor. The ion processor 140 has the ability to quickly switch off the applied RF voltage and apply a DC voltage to extract the trapped precursor ions. A suitable flat plate extraction trap, also referred to as a rectilinear ion trap, is further described in U.S. Pat. No. 9,548,195 (B2).

Although an ion processor 140 (third ion trap) is shown in the embodiment of FIG. 4, the skilled person will appreciate that other methods of forming an ion packet of precursor ions may also be provided. For example, relatively slow transfer of ions through a multipole can be used to affect bunching of ions, which can subsequently be ejected as a single packet to the TOF mass analyser 150. Alternatively, orthogonal displacement of precursor ions may be used to form an ion packet. Further details of these alternatives are found in US-A-20030001088 which describes a travelling wave ion bunching method, the contents of which are herein incorporated by reference.

In FIG. 4, the TOF mass analyser 150 shown is a multiple reflection time of flight mass analyser (MR-TOF). The TOF mass analyser 150 is constructed around two opposing ion mirrors 160, 162, elongated in a drift direction. The mirrors are opposed in a direction that is orthogonal to the drift direction. The ion processor 140 injects ions into the first mirror 160 and the ions then oscillate between the two mirrors 160, 162. The angle of ejection of ions from the extraction trap 140 and additional deflectors 170, 172 allow control of the energy of the ions in the drift direction, such that ions are directed down the length of the mirrors 160, 162 as they oscillate, producing a zig-zag trajectory. The mirrors 160, 162 themselves are tilted relative to one another, producing a potential gradient that retards the ions' drift velocity and causes them to be reflected back in the drift dimension and focused onto a detector 180.

Precursor ions accumulated in the ion processor 140 are injected into the TOF mass analyser 150 (second mass analyser) as a packet of ions. The time taken for the precursor ions to arrive at the detector 180 is recorded by the TOF mass analyser 150 and used to generate an MS1 mass spectrum of the precursor ions.

In a third mode of operation of the mass spectrometry system 1, the TOF mass analyser 150 (second mass analyser) may be used to analyse the precursor ions in the MS2 domain (a MS2 analysis).

In order to analyse the precursor ions in the MS2 domain, some of the precursor ions may be transferred from the quadrupole mass filter 70 to the ion routing multipole 120 in a manner similar to second mode of operation discussed above. The precursor ions to be transferred may be an ion scheduler group of ions which have been output from the ion scheduling device 50, or a group of precursor ions which have not been subjected to ion scheduling. The output ions (e.g. the ion scheduler group of ions) may be further mass selected by the quadrupole mass filter 70. For example, the output ions may be further mass selected to include targeted precursor ion species, or further mass filtered using an m/z isolation window of the quadrupole mass filter 70 (e.g. as part of a DIA methodology), as discussed in more detail below.

Ions may then be transferred to the fragmentation chamber 141 of the ion processor 140. The fragmentation chamber 141 is, in the mass spectrometry system 1 of FIG. 4, a higher energy collisional dissociation (HCD) device. A buffer gas may be supplied to the fragmentation chamber 141. When precursor ions are to be fragmented, the kinetic energy of the precursor ions may be increased, so that precursor ions arriving at the fragmentation chamber 141 and colliding with buffer gas molecules results in fragmentation of the precursor ions into fragment ions.

Although a HCD fragmentation chamber 141 is shown in the ion processor 140 of FIG. 4, other fragmentation devices may be employed instead, employing such methods as collision induced dissociation (CID), electron capture dissociation (ECD), electron transfer dissociation (ETD), photodissociation, and so forth.

Fragmented ions may be ejected from the fragmentation chamber 141 into the extraction trap 142 of the ion processor. The ejected fragmented may be accumulated in the extraction trap 142 to form an ion packet. The fragmented ions may then be injected into the TOF mass analyser 150 as described above.

It will be appreciated that in some embodiments, the first mass analyser (orbital trapping mass analyser 110) and the second mass analyser (TOF mass analyser 150) may be operated concurrently. That is to say, it will be appreciated that the mass spectrometry system 1 may be operated in a first mode of operation concurrently with the second or third mode of operation. According to this disclosure, the ion scheduling device 50 may be operated in order to output groups of ions such that the orbital trapping mass analyser 110 and the TOF mass analyser 150 may be operated in an efficient manner and also with improved dynamic range.

The mass spectrometry system 1 may be under the control of a controller (not shown in FIG. 4) which, for example, is configured to control the timing of ejection of the trapping components, to control one or more power supplies (not shown) to set the appropriate potentials on the electrodes of the quadrupoles etc. so as to focus and filter the ions, to capture the mass spectral data from the orbital trapping device 110, to capture the mass spectral data from the orbital trapping mass analyser 110 and the TOF mass analyser 150, control the sequence of MS1 and MS2 analyses and so forth. It will be appreciated that the controller may comprise a computer that may be operated according to a computer program comprising instructions to cause the mass spectrometry system 1 to execute steps in an accordance with the methods described herein.

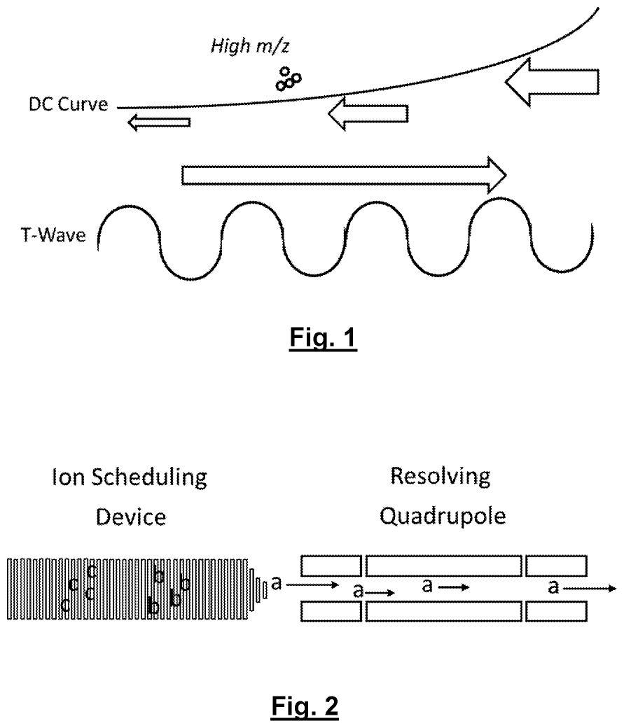

Next methods of ion scheduling utilising an ion scheduling device 50 will be described. FIG. 1 is an explanatory diagram which shows one possible principle of ion scheduling using a travelling wave. Such travelling wave principles of ion scheduling may be utilised by the ion scheduling device 50 of FIG. 4 and the ion scheduling devices 200, 300 of FIGS. 3A and 3B. In FIG. 1, a DC field gradient (an opposing potential gradient) and a travelling wave (a time-varying potential) induce the separation of ions over a length. FIG. 1 shows the travelling wave at a single instance in time; in practice the travelling wave is caused to travel continuously in the first direction (left to right in FIG. 1). The opposing DC and pseudopotential forces cause ions of different m/z to settle at different positions.

To achieve the m/z dependent separation of FIG. 1, ions may be separated by opposing a potential gradient (e.g. a static field) with a pseudopotential force generated by a dynamic (time-varying) potential. In some ion scheduling devices 50 of the present disclosure, an axial pseudopotential generated by a travelling wave opposes a rising DC gradient. Such a traveling wave could be a multi-phase (e.g. 4-phase, or higher) travelling wave. The pseudopotential force pushes ions until they reach a region where the DC force is equal to or greater than the pseudopotential force, at which point the ions become trapped (or if the DC gradient is insufficient then the ions are pushed out of the device). As pseudopotential force is dependent on m/z, the trapping position of the ions also depends on their m/z. Hence, ions may be trapped at various different positions in the separation (first) direction.

Separated ions may be released from the ion scheduling device 50 in an m/z-dependent fashion by scanning/stepping the applied DC potential or the travelling wave amplitude/frequency (or duty cycle/pulse velocity for digital waveforms). Alternatively, many other ways of extracting ions from the guide may be applied: the DC gradient and traveling wave may be removed and ions released over time based on their spatial separation/drift time, or a very slow travelling wave applied to drive out ions in slow bunches, etc. Accumulated ions may then be released, for example to a quadrupole (or other mass filter) matching their m/z or ion mobility, and the losses at the quadrupole may thus be mitigated.

Because the application of a travelling wave potential typically requires axial segmentation of electrodes, the arrangement in FIG. 1 may be implemented using a stacked ring ion guide and/or related structures. FIG. 3a shows an example of a linear ion scheduling device 200, which is an apparatus for separating ions in which the approach of FIG. 1 may be implemented. The linear ion scheduling device 200 comprises a separator region 201, a pre-accumulation region 202, a funnel/initial capture region 203, and an ion outlet 204.

In this specific example, the linear ion scheduling device 200 has a stacked ring structure, also including optional sections for ion capture from an inlet capillary and a pre-accumulation region 202 to maximise duty cycle. In addition to a separation region 201, in which a traveling wave and DC gradient are applied, the single ion trap ion scheduling device 200 is shown as comprising a similar pre-accumulation region 202 for pre-accumulation of ions whilst the separator 201 is in operation. An ion funnel 203 may receive ions from an inlet capillary, or from an ion gate as shown in FIG. 4, and a small, funnelled region compresses the extracted ions as the ions pass out of the device to a higher vacuum (lower pressure) region. The funnelled 203 and pre-accumulation regions 202 may have their own DC offsets and gradients imposed, and a controllable (i.e. variable) DC barrier may be provided between the accumulator 202 and the separator 201. Potentials (e.g. from auxiliary electrodes, which are not shown) can be applied within the guide to cause the ions to move laterally (i.e. perpendicular to the axis of the ion guide), to permit spreading of high amounts of charge over a wider area to reduce space charge effects. After the ions have passed through the separation region 201, they exit the apparatus through the ion outlet 204, for example to a higher vacuum (lower pressure) ion guide. Hence, in generalised terms, the separation regions and/or accumulation regions described herein may be a vacuum region(s). The separation region and/or accumulation regions may be at a lower pressure than an upstream region (i.e. a region that is upstream of the separation region and/or accumulation region) of the apparatus and/or may be at a higher pressure than a downstream region (i.e. a region that is downstream of the separation region and/or accumulation region) of the apparatus. Various gas-tight housings and pumping can be provided to ensure a vacuum is formed.

The properties of the travelling wave may preferably be set such that ions pass through the waves, such that the ions feel the influence of a pseudopotential force rather than being completely entrained in the waves. For example, the frequency and/or voltage amplitude of the travelling wave may be varied to achieve this. In principle, a high enough travelling wave potential will just carry ions away and there will be no separation, unless an opposing DC is set high enough to balance this effect. Therefore, the opposing potential and the time-varying potential may be fine-tuned to optimise separation performance.

The linear ion scheduling device 200 may be operated to output ions separated according to their m/z. The linear ion scheduling device 200 may be provided in the mass spectrometry system 1 of FIG. 4 in place of the ion scheduling device 50. Firstly, ions may be transferred from the injection flatapole 40 to the pre-accumulation region 202 via the ion funnel 203. Ions (e.g. ions of mixed m/z, if not selectively attenuated prior to the ion scheduling device) may accumulate in the pre-accumulation region to form a packet of ions. The packet of ions is then transferred from the pre-accumulation region 203 to the separation region 201, which may be achieved via application of either DC gradient/offset across the pre-accumulation region 203 or a travelling wave to push ions along. Once the pre-accumulation region 203 has been emptied of ions, the further transfer of ions from pre-accumulation region 203 to the separation region 201 is blocked (e.g., by activating an ion gate) and the pre-accumulation region 203 begins accumulating further ions as they enter. In parallel to this, the process of separation begins in the separation region 201. The DC potential is reduced (or alternatively an increase in travelling wave amplitude is provided, or both) to the level required for the first, lowest, m/z extraction window to exit. After a short delay (typically on the order of 0.25-5 ms), the ions within the first m/z extraction window exit the system and travel to the downstream quadrupole (or other mass filter) for finer isolation. The DC potential may then be further reduced to the next m/z extraction window in the sequence and so on until the m/z range of interest is exhausted (i.e. m/z extraction windows spanning the m/z range of interest have each been emptied of ions), whereupon the accumulation region may be once again emptied, and the cycle repeated.

Thus, in each cycle of the linear ion scheduling device 200, ions may be output from the linear ion scheduling device 200 according to their m/z. That is to say, ions may be output from the linear ion scheduling device 200 in a sequence of generally increasing m/z. Of course, in other embodiments the ions may be released in order of descending m/z. In particular, ions may be output from the linear ion scheduling device 200 in a sequence of m/z extraction windows. It will be appreciated that the general techniques of ion scheduling described in relation to the linear ion trap 200 may also be applied to the bypass ion scheduling device 300 of FIG. 3B and the multiple-ion trap ion scheduling device 400 of FIG. 3C. Similarly, ions may also be separated according to their ion mobility, in order of increasing ion mobility or decreasing ion mobility.

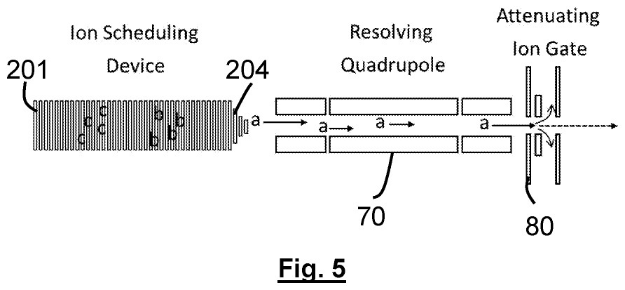

Next, the general operation of an ion scheduling device 50 will be described. The following discussion will describe the operation of the linear ion scheduling device 200 as shown in FIG. 3A, but it will be appreciated that the principles described herein may be applied to other types of ion scheduling devices 50. FIG. 5 shows a schematic diagram of an arrangement of the separation region 201 and the ion outlet 204 of the linear ion scheduling device 200, a quadrupole mass filter 70, and an attenuating ion gate 80.

As shown in FIG. 5, ions are separated into ion scheduler groups in the separation region 201 of the linear ion scheduling device 200. In FIG. 5, three ion scheduler groups of ions are depicted (“a”, “b” and “c”), although additional ion groups may also be provided. Ions within each group have different m/z. For example, the mass spectrometry system 1 may have a m/z range of interest of 300 m/z to 900 m/z. Within this m/z range of interest, each ion scheduler group of ions may each span a m/z extraction window. For example, each m/z extraction window width may be at least: 50 m/z, 70 m/z, 100 m/z, 150 m/z, 200 m/z. The ions may be scheduled such that the ions within the “a” group have relatively low m/z, followed by ions within the “b” group having a higher m/z, ions within the “c” group having a higher still m/z and so on.

As shown in FIG. 5, ions may be output from the linear ion scheduling device 200 in approximate m/z order, wherein they are further isolated by quadrupole mas filter 70. Before injection into a mass analyser (e.g. TOF mass analyser 150), each ion scheduler group of ions passes through attenuating ion gate 80. Attenuating ion gate 80 is configured to selectively attenuate each ion scheduler group of ions based on its intensity. The intensity of an ion scheduler group of ions may be known or predicted from previous analyses or survey analyses in the same manner as conventional automatic gain control methods. The attenuating ion gate 80 may attenuate an ion scheduler group of ions by closing the ion gate for a specified period as the ions transit through the attenuating ion gate 80. That is, the attenuating ion gate 80 applies or removes a deflector potential for a specific period, or by repeated opening and closing in a pulse width modulated fashion, or by application of an RF potential. As such, it will be appreciated that there are various techniques by which the attenuating ion gate 80 may allow substantially all ions of the ion scheduler group, some ions, or no ions of the ion scheduler group to pass through the attenuating ion gate for further analysis by the mass spectrometry system 1.

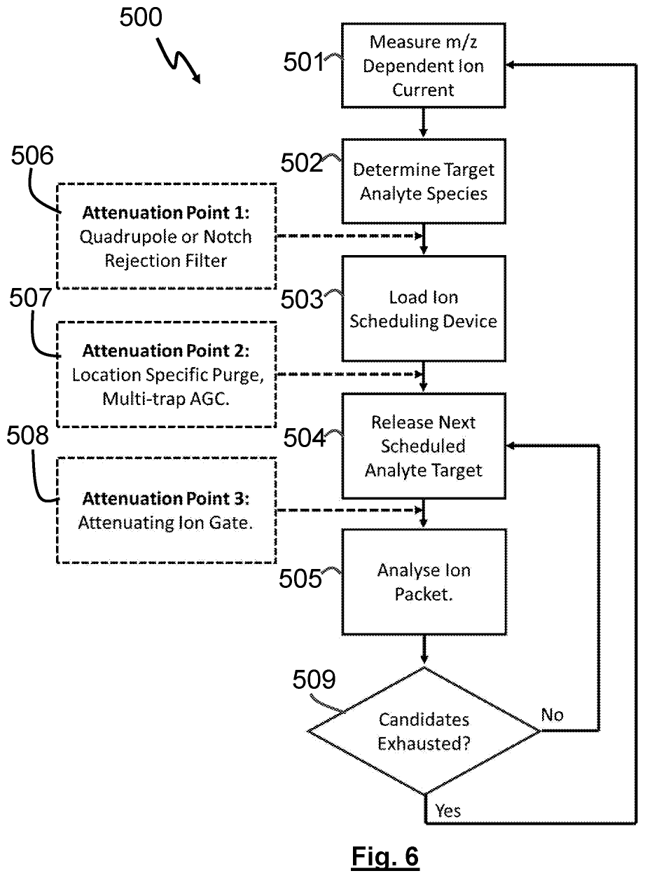

Next a method 500 of scheduling ions for analysis by a mass analyser over a m/z range of interest will be described with reference to the flow chart of FIG. 6. As shown in step 501 of the method 500, the method comprises measuring a m/z dependent ion current. As such, in an initial step of the method, the mass spectrometry system 1 may perform a survey analysis of the ions in order to obtain predicted intensities and associated m/z for the ions across the m/z range of interest. Other techniques for obtaining predicted intensities and associated m/z for the ions across the mass range of interest may also be used in place of a survey analysis.

In step 502, the method may optionally comprise determining target analyte species. For example, in a DDA analysis, step 502 may comprise determining target analyte species from the obtained predicted intensities and associated m/z for the ions obtaining in step 501. Alternatively, the determined target analyte species may be provided by reference to an external data source.

In some embodiments, step 502 may also comprise identifying one or more relatively intense precursor ions within the m/z range of interest. A relatively intense precursor ion may be identified as any precursor ion having an intensity in the survey analysis (or any other previously performed analysis, such as a MS1 analysis from an earlier cycle of the mass spectrometry system 1) above a predetermined threshold intensity. For example, step 502 may comprise identifying, from the predicted intensities and associated m/z, a list of m/z of ions having an associated predicted intensity above a predetermined threshold intensity. The list may be used in the method to identify m/z of ions for selective attenuation. The intensity threshold may be determined based on the ion capacity and/or dynamic range of one or more components of the mass spectrometry system for example.

In some embodiments, the list of predicted intensities may be generated from one or more previous analyses and a predictive algorithm configured to model the elution of a chromatographic peak. As such, the predictive algorithm may be applied to model the evolution of a chromatographic peak as it elutes from a chromatographic apparatus. It will be appreciated that a typical ion scheduler cycle may have a duration of about e.g. 100 ms, while a chromatographic peak may elute over several seconds. So, the predictive algorithm may utilise data from e.g. a plurality of consecutive ion scheduler cycles to predict the intensity of the chromatographic peak (and associated precursor ions) over subsequent ion scheduling cycles.

In step 503, ions are input to the ion scheduling device 50 from the ESI source 20. Ions may then be separated into groups by the ion scheduling device, wherein ion scheduler groups of ions are subsequently (step 504) output (released) by the ion scheduling device 50 according to their m/z. In step 505, ion scheduler groups of ions output from the ion scheduling device 50 are then mass analysed, either using orbital trapping mass analyser 110 or TOF mass 150. In other mass spectrometry systems, other mass analysers such as ion trap mass analysers and quadrupole mass analysers may be used to analyse the ions either in addition to orbital trapping mass analyser 110 and TOF mass analyser 150 or as an alternative to one or both.

As shown in FIG. 6, the method 500 comprises one or more additional steps 506, 507, 508 of attenuating ions. As will be appreciated from FIG. 6, ions may be selectively attenuated at one or more of three points during the method 500. In optional step 506 (attenuation point 1), ions may be selectively attenuated prior to their injection into the ion scheduling device 50. In optional step 507 (attenuation point 2), ions may be selectively attenuated whilst they are within the ion scheduling device 50. In optional step 508 (attenuation point 3), ions may be selectively attenuated following their ejection from the ion scheduling device 50. These three attenuation points will be described in further detail below.

In each of steps 506, 507, and 508, ions may be selectively attenuated according to the predicted intensities and associated m/z of the ions. In particular, the list of relatively intense precursor ions may be used to identify specific m/z, or ion scheduler groups comprising the specified m/z for selective attenuation. For example, where the list of m/z identifies a relatively intense precursor ion at e.g. 700 m/z, an ion scheduler group of ions including ions of m/z 700 may be selectively attenuated.

According to the method 500, in steps 504 and 505, an ion scheduler group of ions is output from the ion scheduling device for m/z analysis. As shown in step 509, steps 504 and 505 of releasing and analysing ion scheduler groups of ions may be repeated until the ions within the m/z range of interest in the ion scheduling device 50 are exhausted. At this point, one cycle of operating the ion scheduling device 50 is effectively completed and the method 500 may return to step 501. In some embodiments, the method 500 may not perform a survey analysis between each cycle of the ion scheduling device 50. That is to say, in some embodiments, steps 501 and 502 may not be performed at the start of each cycle. Rather, in some embodiments, once the ions within the ion scheduling device 50 are exhausted in step 508, the method may return to step 503 and load the ion scheduling device 50 with further ions for analysis.

In some embodiments, the method 500 may be utilised to perform a DIA methodology. For example, in a DIA methodology according to this disclosure, a single cycle of the DIA methodology analyses ions over a m/z range of interest of 300 m/z to 900 m/z. For the DIA methodology, a plurality of MS2 analyses of the ions are to be performed, each MS2 analysis having an isolation window of 10 m/z. Such a DIA methodology may be used for a typical proteomics analysis.

In some methodologies, such as the DIA methodology set out above, the isolation window for each MS2 analysis may be narrower than the m/z extraction window of the ion scheduling device. For example, the ion scheduling device 200 may have a m/z extraction window of about 100 m/z. In such cases, ion scheduler groups of ions output by the ion scheduling device 200 may be further mass filtered by the quadrupole mass filter 70, in order to further mass select ions within each group to the desired m/z isolation window. As such, the quadrupole mass filter 70 may mass filter each ion scheduler group of ions output from the ion scheduling device 50. For each ion scheduler group of ions, the quadrupole mass filter 70 outputs a filtered groups of ions to e.g. the TOF mass analyser 150, wherein each filtered group of ions spans a m/z isolation window for the DIA methodology.

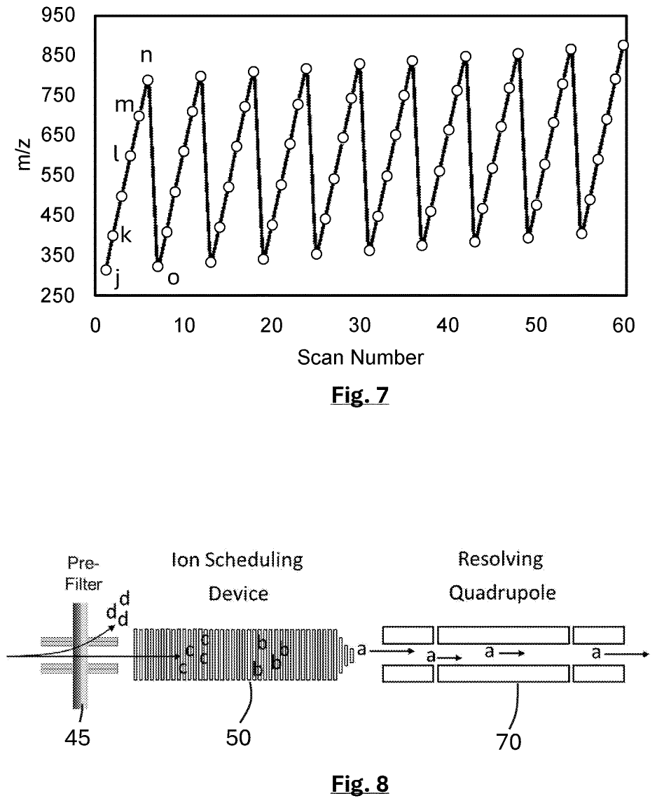

FIG. 7 shows a graph of the m/z of filtered groups of ions scheduled for analysis according to the DIA methodology. As will be appreciated from FIG. 7, the ion scheduling device 200 initially outputs an ion scheduler group of ions with a 100 m/z extraction window ranging from 300 m/z to 400 m/z. This ion scheduler group of ions is then further mass selected by the quadrupole mass filter 70 to an m/z isolation window within the range 300-400 m/z which has not yet been analysed in the DIA cycle. In the embodiment of FIG. 7, a 10 m/z isolation window is applied such that the first filtered group of ions (labelled j) range from 300 m/z to 310 m/z. The next ion scheduler group of ions output by the ion scheduling device 50 with a 100 m/z extraction window ranges from 400 m/z to 500 m/z. A 10 m/z isolation window is then applied to these ions in order to select an isolation window within the 400 m/z to 500 m/z which has not yet been analysed in the DIA cycle. In FIG. 7, the second filtered group of ions (labelled k) ranges from 400 m/z to 410 m/z. As will be appreciated from FIG. 6, the ion scheduling device 50 continues to output ion scheduler groups of ions according to sequential m/z extraction windows, which are then further mass filtered to produce filtered ion groups l, m, and n. Following this, the ion scheduling device 50 will have completed a cycle, as all ions within the m/z range of interest have been output from the ion scheduling device 50. Thus, the ion scheduling device 50 is re-filled and further ion scheduler groups of ions are output sequentially from the ion scheduling device 50. As will be appreciated from FIG. 7, the quadrupole mass filter 70 then applies a 10 m/z isolation to select different m/z ranges which have not yet been analysed in the DIA cycle. For example, the filtered group of ions labelled “o” in FIG. 7 may range from 310 m/z to 320 m/z.

As will be appreciated from FIG. 7, the ion scheduling device 50 may require 10 cycles in order to output enough ion scheduler groups to cover the 300 m/z to 900 m/z range of interest with 10 m/z isolation windows. While the graph of FIG. 7 shows one possible order for selecting filtered groups of ions from within ion scheduler groups output by the ion scheduling device 50, it will be appreciated that any suitable order may be utilised. Accordingly, it will be appreciated that the quadrupole mass filter 70 may be used in conjunction with the ion scheduling device 50 to output well separated targets only by spreading the relatively narrow 10 m/z wide targets among multiple cycles of the ion scheduling device 50.

In addition to the DIA methodology of FIG. 7, it will be appreciated that methods of ion scheduling according to this disclosure may also be applied to a DDA methodology. For example, the method 500 of FIG. 6 described above may also be applied to a DDA methodology. As part of a DDA methodology, the method may further comprise a step of obtaining a list of target m/z of interest. The target list of m/z of interest may be obtained at the start of the method or following a survey analysis of the ions (Step 501). The target list of m/z of interest may comprise the top N (N=5, 10, 15, etc) precursors identified in the survey spectrum, or any other suitable DDA methodology for analysing a sample. The method 500 may then continue as set out in FIG. 6, wherein the ions scheduled to be output from the ion scheduling device are selected based on the list of target m/z of interest. Similar to the DIA methodology discussed above, where multiple DDA target m/z are closely spaced together (i.e. within an m/z extraction window of the ion scheduling device), multiple cycles of the ion scheduling device may be required to analyses all target m/z. As multiple cycles of the ion scheduling device may be performed as part of a DDA methodology, it will be appreciated that the techniques of selectively attenuating ions in order to improve the dynamic range of the ions scheduled for analysis may also be applied to DDA methodologies.

As discussed above in relation to FIG. 6, methods of ion scheduling according to this disclosure include one or more additional steps of selective attenuation of ions. It will be appreciated that such steps of selective attenuation of ions are to be contrasted from any mass filtering steps performed by the quadrupole mass filter 70, as further explained below.

As shown in FIG. 5, and as set out in step 508 of method 500, in some embodiments, ions may be selectively attenuated after being output from the ion scheduling device 50. For example, as shown in FIG. 5, ions may be selectively attenuated by an attenuating ion gate 80 which is downstream of the ion scheduling device 50. The attenuating ion gate 80 may also be downstream of the quadrupole mass filter 70.

As such, in step 508 the mass spectrometry system 1 may identify ion scheduler groups, or filtered groups of ions which are relatively intense from the obtained predicted intensities and associated m/z. For each identified group of ions, the mass spectrometry system may selectively control the attenuating ion gate 80 to selectively attenuate the group of ions. In the embodiment of FIG. 5, the attenuating ion gate 80 may selectively attenuate filtered groups of ions which are identified as being relatively intense. Relatively low intensity groups of filtered ions are not attenuated by the attenuating ion gate 80. As such, step 508 may provide for an improved dynamic range of ions output for analysis in a manner similar to HDR or Boxcar scanning methodologies, but in a manner which makes more efficient, or continuous usage of the available ions. As the ion scheduling device 50 outputs ions in order of m/z or linked mobility, the downstream attenuating ion gate 80 may operate on the released ions in sequence. This methodology avoids having to restrict injection time over multiple separate injections, as with HDR or Boxcar scanning strategies, leading to improved usage of the ion stream.

As shown in FIG. 6, in some embodiments of this disclosure, ions may be selectively attenuated prior to entering the ion scheduling device 50 (step 506). FIG. 8 shows a schematic diagram of an ion scheduling device 50, a quadrupole mass filter 70 and an upstream mass filtering device 45. The quadrupole mass filter 70 and ion scheduling device 50 may be arranged as described above in relation to FIG. 4. The ion scheduling device 50 may be any of the ion scheduling devices described herein, for example the linear ion scheduling device 200. Upstream mass filtering device 45 may be a further quadrupole mass filter, often referred to as an injection filter, or pre-filter.

According to step 508 described above, ions may be selectively attenuated after leaving the ion scheduling device 50. One consequence of such a strategy is that relatively intense ions may intermingle with relatively low intensity ions when accumulating in the ion scheduling device. This in turn may lead to overfilling of the ion scheduling device, thereby impacting the longer accumulation times that would be preferable for improving the ion count of the relatively low intensity ions.

In view of this, step 506 of method 500 may provide for the exclusion of one or more relatively high intensity precursors from one or more cycles of the ion scheduling device 50. As such, method 500, for example as part of step 502, may identify from the predicted intensities and associated m/z, a first m/z of an ion having an associated predicted intensity above a predetermined threshold intensity. Step 506 may then mass filter ions having the first m/z using the upstream mass filtering device 45, wherein the mass filtered ions are input to the ion scheduling device 50. By removing the relatively intense ions of first m/z from the ions input to the ion scheduling device 50, relatively lower intensity ions may be accumulated without overfilling the ion scheduling device 50, thereby improving the dynamic range of the ions output from the ion scheduling device 50.

For example, in a first analysis step, the upstream mass filtering device 45 may mass filter the ions having the first m/z and input the filtered ions to the ion scheduling device 50. In a second analysis step, ions having the first m/z may be output to a mass analyser (e.g. TOF mass analyser 150) for mass analysis. For example, in the embodiment of FIG. 4 where the ion scheduling device 50 includes a bypass region 54, ions of the first m/z may be output via the bypass region 54 for analysis by the mass spectrometry system 1. In effect, the mass spectrometry system 1 may schedule a single ion monitoring acquisition for the ions of the first m/z and exclude the ions of the first m/z from the ion separation path 52 of the ion scheduling device 50.

In effect, ions having the first m/z may be excluded from ions input to the ion separation path 52 by means of a notch mass filtering device. Such a device may reject or attenuate a relatively narrow m/z range from the m/z range of interest including the first m/z. As such, the notch mass filtering device may be configured to remove “notches” out of the ion population m/z range. One such notch mass filtering device comprises an additional RF oscillator which is applied to a quadrupole ion guide, or the pre-filter of FIG. 8, in resonance to the oscillations of target first m/z ions. Such a notch mass filtering device is further described in at least Miller, P. E., & Denton, M. B. (1990), “A notch rejection quadrupole mass filter”, International journal of mass spectrometry and ion processes, 96(1), 17-26). In some embodiments, multiple notches may be applied to remove two or more relatively intense species from the m/z range of interest through application of multiple additional sinusoidal waveforms. Such waveforms may be used to induce resonant ejection of multiple high intensity species without greatly harming the wide mass range of target species, for example as described further in Belov, M. E., Nikolaev, E. N., Anderson, G. A., Auberry, K. J., Harkewicz, R., & Smith, R. D. (2001), “Electrospray ionization-Fourier transform ion cyclotron mass spectrometry using ion preselection and external accumulation for ultrahigh sensitivity” Journal of the American Society for Mass Spectrometry, 12(1), 38-48).

As an alternative strategy to the use of a notch filter, the ions input to the ion scheduling device 50 may also be separated into two or more passbands for input into different cycles of the ion scheduling device 50. As such, the method 500 may comprise in step 502 identifying a first m/z of an ion having an associated predicted intensity above a predetermined threshold intensity, and based on the first m/z, identifying a first passband m/z range of interest having m/z below the first m/z, and a second passband m/z range of interest having m/z above the first m/z. For example, to remove a relatively intense precursor ion at m/z 700, the DIA scan of FIG. 7 might identify a first passband m/z range of 300-690 m/z, and a second passband m/z range of 710-900 m/z. Thus, in a first analysis step, the upstream mass filtering device 45 provides ions within the first passband m/z range of interest (300-690 m/z) to the ion scheduling device 50. In a second analysis step, the upstream mass filtering device 45 provides ions within the second passband m/z range of interest (710-900 m/z) to the ion scheduling device. In a third analysis step, ions having the first m/z are provided to the mass analyser for mass analysis. For example, ions around m/z 700 might be examined by a traditional MS2 analysis bypassing the ion scheduling device 50, or in its own short cycle with any other reasonably intense species.

It will be appreciated from the DIA methodology of FIG. 7 that each of the first and second analysis steps for the first and second passbands may each require one or more ion scheduling cycles. The number of ion scheduling cycles for each of the first and second passbands may be dependent on the m/z of the relatively intense ion to remove. In some embodiments, a three or more m/z passband ranges may be provided where two or more relatively intense species are to be selectively attenuated.

As shown in FIG. 6, in some embodiments of this disclosure, according to step 507 ions may be selectively attenuated within the ion scheduling device 50.

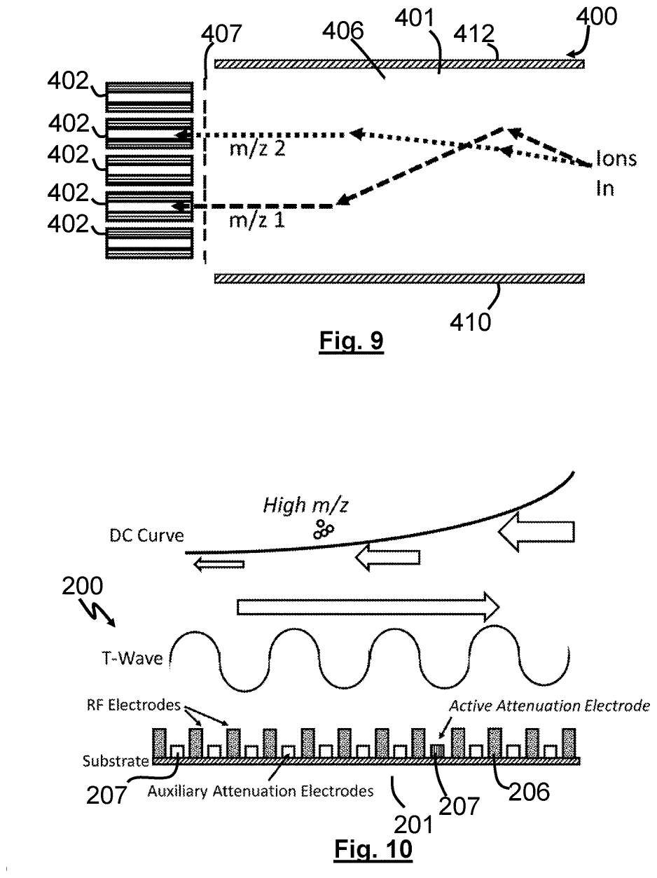

For example, for a multi-ion trap ion scheduling device 400, for example as shown in FIG. 3C), the individual ion traps may be individually controlled in order to affect the selective attenuation. As such, instead of outputting m/z separated ions sequentially from a linear ion scheduling device 50 as described previously, FIG. 9 shows ions of different m/z instead being separated orthogonally (i.e., orthogonally to the general linear direction of the ion scheduling device) by a plurality of RF electrodes 406 of the multi-ion trap ion scheduling device 400. The RF electrodes 406 separate the ions orthogonally in a similar manner to the RF electrodes 206 of other ion scheduling devices through a combination of a traveling wave and a DC potential. Ions are also directed along the axial length of the multi-trap ion scheduling device 400 such that the separated groups of ions are each directed into one of a plurality of ion traps 402 as the ions transit an ion separation region 401 of the multi-ion trap ion scheduling device 400. Ions of different m/z take different paths through the ion separation region 401 and are therefore directed to the different ion traps 402. Ions are confined in the lateral direction (transverse to the axial direction of ion travel) by the RF electrodes 406 and DC guard electrodes 410, 412 provided on opposing sides of the multi-trap ion scheduling device 400.

In generalised terms, each ion trap 402 may define an outlet allowing the ions trapped within the ion trap 402 to exit the ion separation region 401. There can be two, three, four or more ion traps 402, with each being used to permit ions of a respective m/z acceptance window to exit the ion separation region 401. The plurality of m/z acceptance windows provided by the plurality of ion traps 402 may span the m/z range of interest. For example, for a m/z range of interest of 300-900 m/z, the five ion traps 402 may have m/z acceptance windows of 300-420 m/z, 420-540 m/z, 540-660 m/z, 660-780 m/z, and 780-900 m/z.

The range of m/z of ions that pass through each ion trap 402 can be adjusted or tuned, for example through appropriate selection of voltages applied by the electrode arrangements and/or by adjustment of gas flows within the separation region. Thus, ions of a given m/z could be directed to a certain ion trap 402 of the plurality of ion traps 402 under certain conditions but could be directed to a different ion trap 402 under other conditions.

The plurality of ion traps 402 are preferably spaced apart in direction transverse to the axial length of the ion scheduling device 400. Thus, the ions that separate in the transverse direction are divided into ion scheduler groups of ions corresponding to m/z extraction windows of the ion traps 402 of the ion scheduling device 400.

An additional potential (e.g. a DC force) may be applied to the multi-ion trap ion scheduling device 400 to pull ions towards the exits along the axial length of the device 400 (i.e. horizontally in FIG. 3C). For example, a DC gradient may be applied to a DC-only top plate PCB (not shown in FIG. 3C), or a shaped counter-electrode (if RF carpet type), or additional DC electrodes mounted between the RF electrodes 406, or by shaping of the RF electrodes 406. In the embodiment of FIG. 3C, the individual RF electrodes 406 extend along the axial length of the ion scheduling device 400, i.e. the electrodes extend towards the outlets of the ion traps 402 or are orthogonal to the direction in which the plurality of ion traps are spaced apart. Therefore, the RF electrodes 406 may have the travelling wave/opposing DC applied directly to them in order to separate the ions into ion scheduler groups. Further configurations of a multi-ion trap ion scheduling device 400 are described in GB 2312733.5, the contents of which are herein incorporated by reference.

Each of the plurality of ion traps 402 may include an ion gate 407. Each ion gate 407 may be associated with a respective ion trap 402. FIG. 9 shows a schematic diagram of a multi-ion trap ion scheduling device 400, which depicts an ion gate 407 associated with each ion trap 402. Effectively, the plurality of ion gates 407 form an ion gate array for the selective attenuation of ions in the multi-ion trap ion scheduling device 400. As such, each ion gate 407 controls the admission of ions within the m/z acceptance window to the associated ion trap 402. Accordingly, each of the plurality of ion gates 407 may selectively attenuate ions within the m/z acceptance window of the associated ion trap based on the predicted intensities and associated m/z of the ions.

For example, where the predicted intensities identify an ion of a first m/z having an intensity above a predetermined threshold, the method may identify an m/z acceptance window associated with the first m/z. For example, if the first m/z is 700 m/z, the ion trap 402 spanning 660-780 m/z may be identified, and the ion gate 407 associated with the ion trap 402 may be controlled to attenuate ions within the m/z acceptance window. In effect, the method may determine, for each ion gate, an ion accumulation time for ions within the m/z acceptance window of the associated ion trap based on the predicted intensities and associated m/z of the ions. In this way, when a single high intensity precursor is poised to flood an ion trap 402, other ion traps 402 may not be affected by the presence of the relatively high intensity precursor. As such, the accumulation of ions in the other ion traps 402 may continue without attenuation of any other m/z acceptance windows. In some embodiments, the ion accumulation time for each ion trap 402 may be individually determined/controlled, so that each trap possesses its own automatic gain control.

In some embodiments, where relatively intense precursor ions might risk overfilling a single ion trap 402 (or cross into an adjacent ion trap 402), the ion gates 407 further provide for attenuation of the relatively intense precursor, albeit though other near m/z species that would fall into the same ion trap 402 will also be attenuated.

Once a suitable quantity of ions are accumulated within the ion traps 402, the ion traps may be controlled to output ions sequentially in ion scheduler groups of ions, wherein each ion scheduler group corresponds to the ions trapped within one (or a selection) of the ion traps 402. By using the ions gates 407 to selectively attenuate some ion species, an accumulation time for the ion traps of the ion scheduling device may be extended to allow for an improved quantity of relatively low intensity precursor ions to be accumulated within at least some of the ion traps 402, without overfilling of other ion traps 402 (e.g. due to high intensity precursor ions) affecting the accumulation.

As will be appreciated from FIG. 9, ions may be selectively attenuated within a muti-ion trap ion scheduling device 400 by means of a plurality of ion gates and/or ion traps. For a linear ion scheduling device 200 (i.e. where ions are separated according to their m/z in the axial direction), ions may also be selectively attenuated as further described below. For example, FIG. 10 shows a schematic diagram of a linear ion scheduling device 200 which includes one or more attenuation electrodes 207 for selectively attenuating ions. FIG. 10 shows a schematic diagram of a cross section of the ion separation region 201 of the linear ion scheduling device 200. As will be appreciated from FIG. 3A, the ion separation region 201 is downstream from the ion accumulation regions. The ion separation region 201 include a plurality of RF electrodes 206 (e.g. in the form of a stacked ring ion guide), each RF electrode 206 spaced apart from the other RF electrodes 206 in the axial direction.

As explained above, ions are initially accumulated in the ion accumulation region 202, before being transferred to the ion separation region 201. In the ion separation region 201, ions are separated into different groups of ions according to their m/z or ion mobility. The groups of ions are spatially separated along the axial length of the ion separation region 201 due to the interaction of the travelling wave and the applied DC potential. By way of explanation, separated groups of ions are indicated schematically in FIG. 10 above the ion scheduling device 200. As shown in FIG. 10, the ion scheduling device 200 comprises one or more attenuation electrodes 207. In the embodiment of FIG. 10, the attenuation electrodes 207 are provided between adjacent RF electrodes 206 along the axial length of the ion scheduling device 200. Each attenuation electrode 207 may be associated with a respective region of the ion separation region 201 of the ion scheduling device 200. That is, the one or more attenuation electrodes 207 may be provided as part of the ion scheduling device 200 in order to selectively remove ions present in the associated region of the ion separation region 201.

In the embodiment of FIG. 10, a plurality of attenuation electrodes 207 are provided along the axial length of the ion scheduling device 200. The one or more attenuation electrodes 207 are configured to attenuate or remove ions from the ion scheduling device 200 when supplied with an ion removal voltage.

For example, as shown in FIG. 10, an attenuation electrode 207 may be “activated” by supplying a voltage to it (e.g. a DC voltage). The DC voltage applied to one or more attenuation electrode 207 may perturb ions trapped within the traveling wave adjacent to the active attenuation electrode 207 such that they are removed from the device (i.e. the ions are removed from the ions scheduled to be output by the ion scheduling device 200). For example, an attractive potential (i.e. a potential of opposite polarity to the ions) may be applied to an attenuation electrode 207 to attract ions towards the attenuation electrode 207 and out of the ion separation region 201. It will be appreciated that the attenuation electrodes 207 may track the DC gradient of the ion scheduling device 200 so that the applied DC voltage may suitably perturb the ions. As such, one or more attenuation electrodes 207 may be controlled to selectively remove ions of different m/z from the ion scheduling device. Thus, method step 507 may comprise selectively attenuating the ions by selectively supplying the attenuation electrode 207 with an ion removal voltage in order to selectively attenuate ions based on their predicted intensities and associated m/z.

In the embodiment of FIG. 10, a plurality of attenuation electrodes 207 are arranged along the axial length of the ion separation region 201. Thus, when ions are separated into spatially separate groups of ions in different regions of the ion separation region 201, each group of ions may be proximate to one or more attenuation electrodes 207. Thus, individual groups of ions may be selectively attenuated, or removed entirely from the ion separation region 201 by application of a suitable potential to one or more attenuation electrodes 207 proximal to the group of ions in the ion separation region. In some embodiments, a plurality of groups of ions may be removed in parallel by application of potentials to a plurality of attenuation electrodes in different regions of the ion separation region 201.

In some embodiments, the ion scheduling device outputs 200 the ions sequentially as a plurality of ion scheduler groups, each ions scheduler group spanning a m/z extraction window or ion mobility extraction window such that the plurality of ion scheduler groups cover the m/z range of interest. When supplied with the ion removal voltage, the attenuation electrode 207 may selectively attenuate or remove an ion scheduler group of ions present in the associated region of the ion scheduling device 200. For example, in some embodiments, the one or more attenuation electrodes 207 may be located proximate to the ion outlet 204 of the ion scheduling device 200. As such, each ion scheduler group of ions may pass through a region of the ion scheduling device 200 which may be affected by the attenuation electrode 207. Accordingly, the one or more attenuation electrodes 207 may selectively attenuate ions as they are about to exit the ion scheduling device 200 in accordance with the predicted intensities.

In some embodiments, a plurality of attenuation electrodes 207 may be distributed in the ion scheduling device 200 (e.g. as shown in FIG. 10), wherein each attenuation electrode is associated with a different region of the ion scheduling device. When supplied with an ion removal voltage, each attenuation electrode 207 may selectively attenuate or removes a different ion schedule group of ions present in the ion scheduling device. As such, the plurality of attenuation electrodes 207 may affect the selective attenuation of a plurality of ion scheduler groups of ions in parallel. Moreover, the plurality of attenuation electrodes 207 may allow for the selective removal of an ion scheduler group of ions prior to said group reaching the ion outlet 204. That is to say, selective removal may be effected during an ion separation process of the ion scheduling device 200. For example, ions may be selectively attenuated as part of a multi-step process for filling the ion separation region 201.

As such, in a first fill step ions are input to the ion scheduling device 200 and separated into a plurality of ion scheduler groups in the ion separation region 201. In effect, separated ions are hold a relatively constant equilibrium position along the ion separation region of the ion scheduling device 200 based on their m/z or ion mobility. An ion removal voltage may then be supplied to one or more attenuation electrodes 207 to selectively attenuate or remove one or more ion scheduler groups from the ion scheduling device 200 (e.g. as shown in FIG. 10). For example, a relatively intense precursor ion may be selectively removed as part of the first fill step to prevent the overfilling of the ion scheduling device 200.

In a second fill step, ions are input to the ion scheduling device 200 and separated into the plurality of ion scheduler groups of ions from the first fill step in which the ion removal voltage is not applied to the attenuation electrode. As such, ions from the second fill step are added to the ions from the first fill step. In effect, for ion scheduler groups of relatively low intensity, the total accumulation time is the accumulation time of the first and second fill steps. For ions of the ion scheduler groups which were selectively removed in the first fill step, the accumulation time is only the duration of the second fill step. The durations of the first and second fill steps may be adjusted based on the predicted intensities. For example, the first fill step may be longer than the second fill step, to allow for additional accumulation time of relatively low intensity precursors. In some embodiments, three or more fill steps may be provided, wherein only the final fill step does not apply an attenuation voltage.

Once all the fill steps are completed, the ions are output from the ion scheduling device 200 according to their ion scheduler groups. As such, ions accumulated in a particular ion scheduler group from the first and second fill steps may be output at the same time.

In some embodiments, it may be desirable to selectively attenuate only a portion of the ions of an ion scheduler group. Selective attenuation (i.e. providing the option to remove only a portion of the ions, rather than a binary 0% or 100% of the ions of an ion schedular group) may be implemented using the multiple fill step strategy discussed above. Alternatively, or in addition, selective attenuation may be implemented within the ion scheduler device 200 using the attenuation electrode 207. As such, in some embodiments, one or more of the attenuation electrodes 207 may not extend fully across a width of the device. Alternatively, one or more attenuation electrodes 207 may be segmented into a plurality of attenuation electrode segments (not shown in FIG. 10), wherein a plurality of electrode segments are located at an axial location of the ion scheduling device (similar to attenuation electrode 207). The plurality of attenuation electrode segments may be spaced apart across the width of the ion scheduler device 200 to form a group of attenuation electrode segments. Each of the attenuation electrode segments may be supplied with a DC attenuation voltage independently of the other attenuation electrode segments in the group. Thus, ions of an ion scheduler group which are separated and maintain an equilibrium position proximal to attenuation electrode 207/attenuation electrode segments may be selectively attenuated in proportion to the active attenuation electrode's width, or in proportion to the width of the of active attenuation electrode segments within the group. That is to say, by increasing the number of active attenuation electrode segments, the stronger the attenuation force. For example, in some embodiments, a group of four attenuation electrode segments may be provided in place of a single attenuation electrode 207 of FIG. 10. Accordingly, by activating none of the attenuation electrode segments, 0% of the ions of a local ion scheduler group may be selectively attenuated. As one of the attenuation electrode segments are activated, the selective removal force may increase to remove about 25% of the ions of the ion scheduler group. Activating additional attenuation electrode segments may in turn increase the selective remove to 50%, 75%, and 100% (all four attenuation electrode segments active).

It will be appreciated that the selective control of the attenuation electrode segments may be combined with the multiple fill step strategy discussed above in order to provide further control of the ion population of each group of ions separated by the ion scheduling device 200.

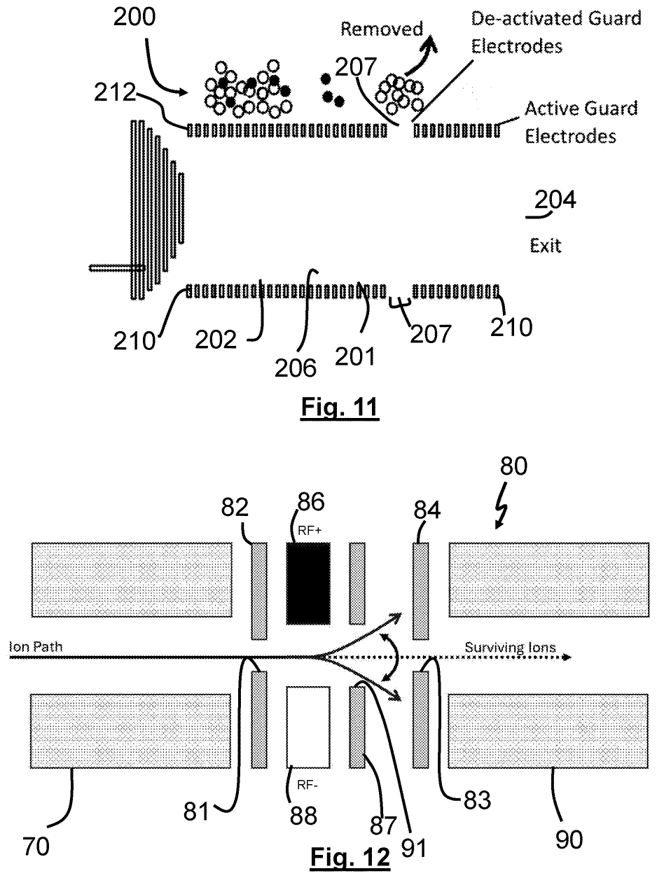

In the embodiment of FIG. 10, the attenuation electrodes 207 are provided between adjacent RF electrodes 206 of the ion scheduler device 200. In other embodiments, for example as shown in FIG. 11, the attenuation electrodes 207 may be implemented as forming part of the DC guard electrodes at the edges of the ion scheduler device 200.

FIG. 11 is a cross-section of a top-down view of the linear ion scheduling device 200. As shown in FIG. 11, the linear ion scheduler device 200 comprises a plurality of DC guard electrodes 210, 212 provided on opposing sides of the linear ion scheduling device 200. The opposing DC guard electrodes 210, 212 are configured to confine ions laterally within the linear ion scheduling device. The RF electrodes 206 extend between the opposing DC guard electrodes along the length of the linear ion scheduling device 200. In some embodiments, a single DC guard electrode may extend along of substantial length of the accumulation region 202 and/or the ion separation region. In the embodiment of FIG. 11, the DC guard electrodes on opposing sides are segmented to form two groups of DC guard electrodes 210, 212 on opposing sides of the linear ion scheduling device 200. In normal operation, a DC confining voltage may be supplied to each of the DC guard electrodes 210, 212 in order to confine ions laterally within the linear ion scheduling device 200.

As shown in FIG. 11, one or more attenuation electrodes 207 may be provided in place of a DC guard electrode 210, 212 at an edge of the linear ion scheduling device 200. In effect one or more DC guard electrode 210, 212 may be replaced along a portion of the axial length of the linear ion scheduling device 200 to allow for ions to be selectively attenuated. The attenuation electrodes 207 may be supplied with the DC confining voltage in order to confine ions within the linear ion scheduling device 200, similar in operation to the DC guard electrodes 210, 212.

In order to cause the selective attenuation of ions, an attenuation voltage may be supplied to attenuation electrodes 207 independently of the DC confining voltage supplied to the DC guard electrodes 210, 212. By varying the voltage supplied to attenuation electrodes 207 (relative to the DC guard electrodes 210, 212), some ions may be allowed to escape the linear ion scheduling device 200 in the region of the attenuation electrodes 207. For example, when selective attenuation of ions is required, the attenuation voltage may be a reduced DC confining voltage (e.g. 10%, 20%, or 50% of the DC confining voltage), no voltage, or an attractive DC voltage (i.e. a voltage of an opposing potential to the DC confining voltage), to cause ions to migrate from a central region of the ion scheduling device and escape via one or more edge regions of the ion scheduling device 200. In order to effect a selective removal of ions of a desired m/z, the attenuation electrodes 207 may only be controlled to remove ions when the desired ions are located in a region proximal to the attenuation electrodes 207. For example, the attenuation electrodes 207 may be provided towards the ion outlet 204 of the linear ion scheduling device 200 such that each ion scheduler group of ions passes the attenuation electrodes 207 before exiting the device 200. Accordingly, as shown in FIG. 11, one or more attenuation electrodes 207 may be associated with a region of the linear ion scheduling device 200, wherein each attenuation electrode 207 of FIG. 11 is configured to selectively attenuate or selectively remove ions from the linear ion scheduling device 200 when supplied with the attenuation voltage.

In some embodiments, it will be appreciated that groups of ions which are intensely populated may have relatively high space charge. This in turn may push some ions of the intensely populated group closer to the guard electrodes 210, 212 of the ion scheduling device 200. A relatively high potential applied to the guard electrodes 210, 212 prevents the ion group expanding further. In some embodiments, one or more guard electrodes 210, 212 may act as an attenuation electrode 207 by having a relatively lower magnitude potential applied to it. By maintaining a region of ‘weaker’ guard electrodes 210, 212 for example close to the outlet 204 (where all ions will pass near them), relatively high intensity ions passing by them may be forced under space charge over the weakened guard barrier. As such, relatively high intensity groups of ions may be selectively attenuated as they transit the region of weaker guard electrodes 210, 212. Such a lower magnitude potential region may be maintained throughout each ion scheduling cycle in order to effectively self-regulate ion population of each ion scheduler group of ions.

In accordance with embodiments of this disclosure, it will be appreciated that an attenuating ion gate 80 may provide for the selective attenuation of ions. In particular, the attenuating ion gate 80 may be provided for the selective attenuation of ions exiting an ion scheduling device 50, as described above. Next, an attenuating ion gate 80 will be described with reference to FIG. 12.

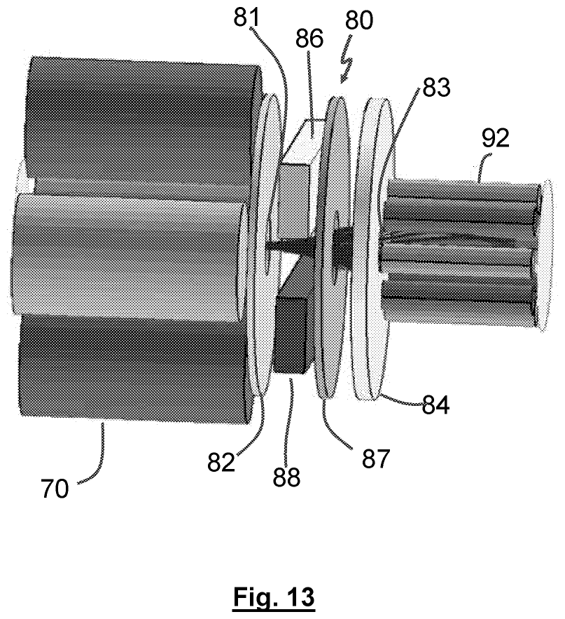

As shown in FIG. 12, the attenuating ion gate 80 comprises a first ion lens 82, a second ion lens 84 and first and second deflector electrodes 86, 88. An isometric view of the attenuating ion gate 80 is shown in FIG. 13.

The first ion lens 82 defines a first aperture 81 through which ions may enter the attenuating ion gate 80. As shown in FIG. 12 (and also indicated in FIG. 4) the attenuating ion gate 80 may receive ions from the quadrupole mass filter 70. As shown in FIGS. 12 and 13, the first ion lens 82 may be a generally circular (or elliptical) plate. A first aperture is formed though the thickness of the plate. The first aperture in the embodiment FIG. 12 is circular, but in other embodiments other shapes of plate and aperture may be used.

The second ion lens 84 defines a second aperture 83 through which ions may exit the attenuating ion gate 80. As shown in FIG. 12 (and also indicated in FIG. 4) the attenuating ion gate 80 may output ions to a transfer multipole 90, for example the octupole 92 shown in FIG. 13. Similar to the first ion lens 82, the second ion lens may be a generally circular (or elliptical) plate. The second aperture 83 is formed though the thickness of the plate. The second aperture 83 in the embodiment FIG. 12 is circular, but in other embodiments other shapes of plate and second aperture 83 may be used.

As shown in FIG. 12, the second ion lens 84 is spaced apart from the first ion lens 82. As such, the first and second ion lenses 82, 84 form a split lens structure. The first and second apertures 81, 83 are also aligned in an axial direction of the attenuating ion gate 80 to define an ion channel between the first and second apertures. Ions transit the attenuating ion gate along the ion channel as indicated by the ion path shown in FIG. 12. It will be appreciated that ions are confined to a generally central region of the ion path (through centres of the first and second apertures) by the potentials applied to the upstream quadrupole mass filter 70, the first and second ion lenses 82, 84 and the transfer multipole 90.

As shown in FIGS. 12 and 13, first and second deflector electrodes 86, 88 are provided on opposing sides of the ion channel between the first ion lens 82 and the second ion lens 84. The first and second deflector electrodes 86, 88 may be spaced apart on opposing sides of the ion channel by a similar distance to the diameter of first and second apertures 81, 83. The first and second deflector electrodes 86, 88 are configured to receive a variable alternating deflector voltage across the first and second deflector electrodes in order to variably attenuate ions passing through the attenuating ion gate. As such, an alternating deflector voltage differential may be applied across the first deflector electrode 86 and the second deflector electrode 88. It will be appreciated that in some embodiments, a common DC offset voltage (e.g. −30 V for positive ions) may also be applied to the first and second deflector electrodes 86, 88

The alternating deflector voltage differential may be a generally sinusoidal waveform, although in some embodiments other alternative waveforms may be applied. As such, the alternating potential applied to the first and second deflector electrodes 86, 88 may replace or supplement binary on/off ion gate control to allow for variable attenuation of ions using lower amplitude voltage waveforms (on/off gating typically utilising DC voltages of no greater than 50 V).

As shown in FIG. 12, a shield electrode 87 may also be provided. The shield electrode 87 defines a shield aperture 91. The shield electrode 87 may be provided between (in the axial direction) the first and second deflector electrodes 86, 88 and the second ion lens 84. In other embodiments, shield electrode 87 may be provided between the first and second deflector electrodes 86, 88 and the first ion lens 82. In some embodiments, two shield electrodes 87 may be provided on opposing axial sides of the first and second deflector electrodes 86, 88.

By applying an alternating deflector voltage to the first and second deflector electrodes 86, 88, ions will be transmitted through the ion channel mainly when the alternating voltage difference between the first and second deflector electrodes 86, 88 is relatively low (e.g. no greater than about 10 V). For example, ions entering the attenuating ion gate 80 at a potential of about ~40 eV, may travel through the attenuating ion gate 80 when the alternating voltage difference is relatively low. By varying (increasing) amplitude (or frequency), the ion beam is caused to spread out radially, in a manner proportional to the increase in frequency and amplitude of the alternative deflector voltage. Thus, an increasing proportion of the ions may then impact or otherwise be deflected by the second (exit) aperture 83, instead of passing into the transfer multipole 90.

The first and second ion lenses 82, 84 may be spaced apart in a manner similar to existing split lens designs. To ensure that ions transit the attenuating ion device 80 without notable ion losses in normal (i.e. fully open) operation, ions may be accelerated to about 40 eV. In some embodiments, the pressure within the ion channel may be relatively low, for example <<1×10⁻³ mbar, such that collisions do not affect ion transit.

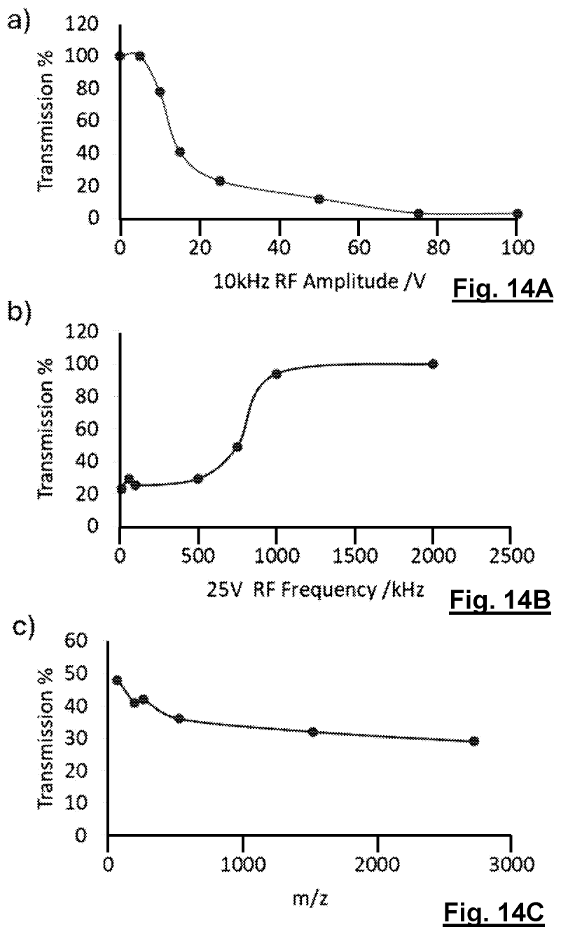

FIG. 13 shows an isometric view of a model of the attenuating ion gate 80 constructed using a three-dimensional computer simulation software package for simulating of ion trajectories (MASIM3D simulation suite). The attenuating ion gate 80 is configured to receive ions from a 4 mm radius quadrupole and to output ions to a 3 mm radius octupole. The simulation suite assumed that ions were generated in the quadrupole with 1 eV energy at +5 V potential and allowed to accelerate through the 2 mm diameter first aperture 81 with the first lens held at −35 V. Positive and negative phases of the alternative deflector voltage were applied to the opposing first and second deflection electrodes 86, 88, as it was found that using a single RF phase caused excessive ion energy perturbations. Ions then passed through the larger aperture of the shield electrode 87 behind the deflector electrodes 86, 88, and then through the second aperture 83 into the 3 mm inscribed radius octupole 90, where they were decelerated to 3 eV. Ions that spread out beyond a 2 mm radial displacement were clipped from the simulation and assumed to be lost, and the proportion of these lost ions determined the transmission estimates shown in FIG. 14 for a range of different simulated alternating deflector voltages.

FIGS. 14A, 14B, and 14C show the results of simulations of different alternative deflector voltages (variable amplitude and variable frequency) on the transmission of ions generated over a 1 ms period. In FIG. 14A the amplitude of a 10 kHz alternating deflector voltage was varied from an amplitude of 0-100 V. For ions of m/z 195, this cause ion transmission to start falling from 100% for voltage amplitudes above about 5 V. At an alternating deflector voltage amplitude of about 15 V, the ion transmission had fallen to 40%, and about 20% at an alternating deflector voltage of 20 V. Due to the relatively small pulse width (e.g. <2 ms) of some ion packets, it may be preferable that an alternating deflector voltage frequency of at least 5 kHz, preferably 10 kHz is used. For high frequency alternating deflector voltages, it would be expected that the amplitudes required to reduce ion transmission would increase, as is typical in RF interactions with ions.

FIG. 14B shows the impact of varying frequency for a 25 V amplitude alternating deflector voltage. As shown in FIG. 14B, the transmission percentage increases with the frequency of the alternating deflector voltage.

FIG. 14C shows the dependency of transmission on m/z of the ions. FIG. 14C utilises a 10 KHz 15 V amplitude alternating deflector voltage, which removes just over half of m/z 195 ions. Higher m/z ions cause a decrease in transmission, as higher m/z, lower velocity ions are more likely to encounter the high deflection potentials more frequently. As will be appreciated from FIG. 14C the variation in transmission is only about 20% over a m/z range of 195 to 2800 m/z and the trend is smooth. As such, in some embodiments the attenuating ion gate may calibrate attenuating ion gate 80 to account for an m/z dependence on ion transmission. For example, the attenuating ion gate 80 may adjust the applied alternating deflector voltage based on the m/z of the ion scheduler group of ions to be selectively attenuated. The calibration may comprise adjusting an amplitude of the alternating deflector voltage based on the m/z of the ions to be selectively attenuated and/or adjusting an amplitude of the alternating deflector voltage based on the m/z of the ions to be calibrated.

While in the embodiment of FIG. 12, deflected ions are depicted as impinging on the second ion lens, in some embodiments the deflected ions may be directed towards a secondary detector such as dynode and the like. The dynode may be positioned off-axis from the second aperture 83. Secondary particles generated by receipt of the ions at the dynode can be directed to a detector of secondary particles or an electron multiplier. In this way, the deflected particles may be used to obtain additional information about the ion beam transiting through the attenuating ion gate. Further description of such a second detector may be found in at least U.S. Pat. No. 11,087,969 B, the contents of which are incorporated by reference.

While the embodiment of FIG. 12 utilises first and second deflector electrodes 86, 88 to apply an alternating voltage, in other embodiments, a DC voltage may also be applied to further attenuate/deflect ions transiting the ion gate. For example, in some embodiments, a differential DC voltage may be additionally applied to the first and second deflector electrodes 86,88 in order to further reduce the transmission of ions through the ion gate 80. In some embodiments, such a differential DC voltage may be applied to e.g. fully close the ion gate.

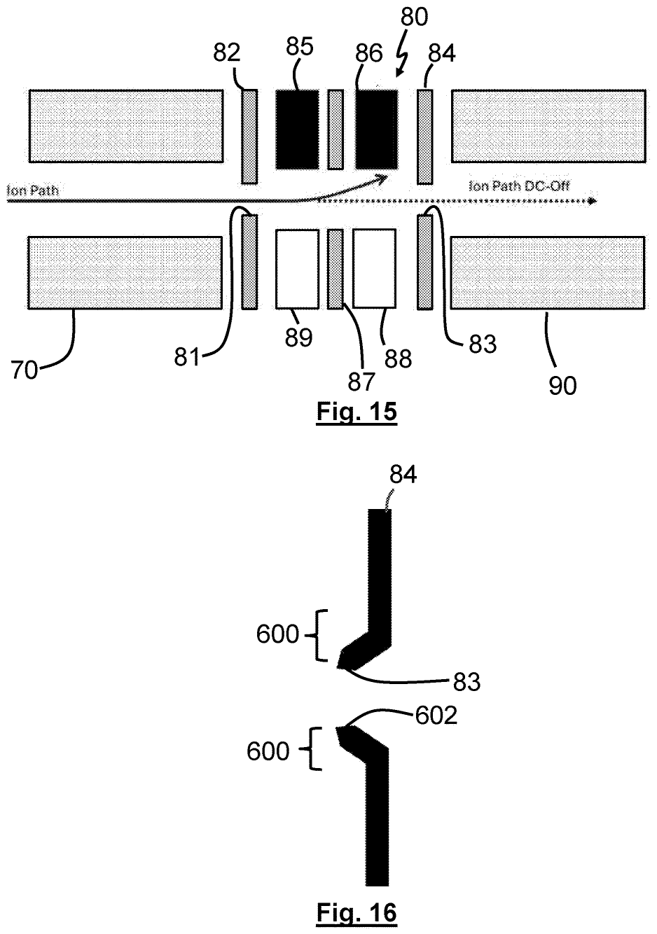

It will be appreciated that the application of the differential DC voltage to first and second deflector electrodes 86, 88 may reduce the effectiveness of the alternating deflector voltage. In particular, conventional differential DC voltages for closing an ion gate often exceed 100 V. To address this, FIG. 15 shows a schematic diagram of an attenuating ion gate 80 including third and fourth deflector electrodes 85, 89. In effect, the structure of this embodiment is similar to a dual-gate split lens, for example as described in U.S. Pat. No. 8,0264,75 B, the contents of which are incorporated by reference.

As shown in FIG. 15, the third and fourth deflector electrodes 85, 89 may have a similar construction to the first and second deflector electrodes 86, 88. In some embodiments, the third deflector electrode and the fourth deflector electrode 85, 89 may be provided (axially) between the first and second deflector electrodes 86, 88 and the first ion lens 82, or between the first and second deflector electrodes 86, 88 and the second ion lens 84.

The third and fourth deflector electrodes 85, 89 may each be configured to selectively receive a DC deflection voltage configured to prevent ions transiting the attenuating ion gate. As such, the (full) opening and (full) closing of the attenuating ion gate by means of DC voltages may be spaced apart in the axial direction from the variable attenuation provided by the first and second deflector electrodes 86, 88. In some embodiments, as shown in FIG. 15, a shield electrode 87 defining a shield aperture 91, may be provided (axially) between the first and second deflector electrodes 86, 88, and the third and fourth deflector electrode 85, 89 in order to shield the relatively large DC voltages from the lower amplitude alternating deflector voltage.

As noted above, when ions exit the attenuating ion gate 80 through the second ion aperture 83, deflected ions may impinge on the second ion lens 82. To reduce wear and/or contamination of the second ion aperture 83, in some embodiments the profile of the second ion aperture in the axial direction may be modified in order to direct (or skim) deflected ions away from second ion aperture 83. An example of such a profile is shown in FIG. 16. As shown in FIG. 16, an edge of the plate defining the second aperture 83 is extruded towards the first ion aperture 82 to define a skimming region 600 of the second ion lens 82 surrounding the second ion aperture 83. As ions deflected by the first and second deflector electrodes 86, 88 may be directed towards the edges of the second aperture 83, the skimming region 600 may allow the second ion lens 82 to direct deflected ions away from contacting an internal surface 602 of the second aperture 83 or at least reduce the number of ions which contact internal surface 602. This in turn may reduce wear/contamination of the second ion lens 82, leading to an improved lifetime of the second aperture.

Thus, according to this disclosure methods of scheduling ions for analysis by a mass spectrometry system are provided in which ions are selectively attenuated based on their m/z and relative intensities.

Embodiments of this disclosure will now be set out with reference to the following numbered clauses.

1. A method of scheduling ions for analysis by a mass analyser over a mass to charge ratio (m/z) range of interest, the method comprising:
obtaining predicted intensities and associated m/z for the ions across the mass range of interest;
inputting ions to an ion scheduling device;
outputting the ions from the ion scheduling device to the mass analyser according to the m/z or ion mobility of the ions; and
selectively attenuating the ions based on the predicted intensities and associated m/z of the ions.

2. A method according to claim 1, wherein
selectively attenuating the ions based on the predicted intensities and associated m/z of the ions comprises:
identifying, from the predicted intensities and associated m/z, a list of m/z of ions having an associated predicted intensity above a predetermined threshold intensity; and
selectively attenuating the ions based on the list of m/z.

3. A method according to claim 1, further comprising:
obtaining a list of target m/z of interest; and
scheduling the output of the ions from the ion scheduling device based on the list of target m/z of interest.

4. A method according to claim 1, wherein
the ion scheduling device outputs the ions sequentially as a plurality of ion scheduler groups, wherein either:
each ion scheduler group spans a m/z extraction window such that the plurality of ion scheduler groups cover the m/z range of interest, or
each ion scheduler group spans an ion mobility range.

5. A method according to claim 4, wherein
a plurality of ion scheduling cycles are performed, wherein, in each ion scheduling cycle:
ions are input to the ion scheduling device, and the ion scheduling device outputs the plurality of ion scheduler groups sequentially for each ion scheduling cycle.

6. A method according to claim 1, further comprising:
mass filtering each ion scheduler group of ions output from the ion scheduling device using a downstream mass filtering device, wherein for each ion scheduler group of ions the mass filtering device outputs a filtered groups of ions to the mass analyzer, each filtered group of ions spanning a m/z isolation window of the mass filtering device.

7. A method according to claim 6, wherein
the mass filtering device updates a position of the m/z isolation window of the mass filtering device for each ion scheduler group of ions output from the ion scheduling device such that the plurality of filtered groups of ions output from the mass filtering device spans the m/z range of interest.

8. A method according to claim 1, wherein
the ions are selectively attenuated by an upstream filtering device prior to the input of the ions to the ion scheduling device.

9. A method according to claim 8, further comprising:
selectively attenuating the ions based on the predicted intensities and associated m/z of the ions comprises:
identifying, from the predicted intensities and associated m/z, a first m/z associated with an ion having a predicted intensity above a predetermined threshold intensity; and
selectively attenuating ions having the first m/z using the upstream mass filtering device, wherein the mass filtered ions are input to the ion scheduling device.

10. A method according to claim 9, further comprising:
in a first analysis step, the upstream mass filtering device selectively attenuates ions having the first m/z, and inputs the ions to the ion scheduling device, and
in a second analysis step, ions having the first m/z are output to the mass analyser for mass analysis.

11. A method according to claim 8, wherein
selectively attenuating the ions based on the predicted intensities and associated m/z of the ions comprises:
identifying, from the predicted intensities and associated m/z, a first m/z associated with an ion having a predicted intensity above a predetermined threshold intensity, and based on the first m/z, identifying a first passband m/z range of interest having m/z below the first m/z, and a second passband m/z range of interest having m/z above the first m/z;
wherein, in a first analysis step, the upstream mass filtering device mass provides ions within the first passband m/z range of interest to the ion scheduling device,
wherein, in a second analysis step, the upstream mass filtering device provides ions within the second passband m/z range of interest are to the ion scheduling device; and
wherein, in a third analysis step, ions having the first m/z are provided to the mass analyser for mass analysis.

12. A method according to claim 11, wherein
one or more of the first analysis step and the second analysis step may each comprise a plurality of ion scheduling cycles.

13-15. (canceled)

16. A method according to claim 1, wherein
the ion scheduling device comprises an attenuation electrode associated with a region of the ion scheduling device, the attenuation electrode configured to attenuate or remove ions from the ion scheduling device when supplied with an ion removal voltage, and
selectively attenuating the ions comprises selectively supplying the attenuation electrode with the ion removal voltage in order to selectively attenuate ions based on their predicted intensities and associated m/z.

17. A method according to claim 16, wherein
the ion scheduling device outputs the ions sequentially as a plurality of ion scheduler groups, each ions scheduler group spanning a m/z extraction window or ion mobility extraction window; and
when supplied with the ion removal voltage, the attenuation electrode selectively attenuates or removes an ion schedule group of ions present in the region of the ion scheduling device associated with the attenuation electrode.

18. (canceled)

19. A method according to claim 17, wherein
in a first fill step:
ions are input to the ion scheduling device, separated into a plurality of ion scheduler groups, and trapped in the ion scheduling device; and
an ion removal voltage is supplied to an attenuation electrode to selectively attenuate or remove an ion schedule group from the ion scheduling device; and
in a second fill step, ions are input to the ion scheduling device and separated into the plurality of ion scheduler groups of ions from the first fill step in which the ion removal voltage is not applied to the attenuation electrode,
wherein ions from the first and second fill steps are output from the ion scheduling device according to their m/z or ion mobility simultaneously.

20. A method according to claim 1, wherein
ions are output to the mass analyser from the ion scheduling device via an attenuating ion gate, wherein the attenuating ion gate selectively attenuates the ions based on the predicted intensities and associated m/z of the ions.

21. A method according to claim 1, wherein
obtaining predicted intensities and associated m/z for the ions across mass range of interest comprises:
determining the predicted intensity and the associated m/z for the ions based on a previous mass analysis performed by the mass analyser.

22. A method according to claim 1, wherein
the ion scheduling device comprises an ion accumulation region in which ions are accumulated; and an ion separation region in which ions from the ion accumulation region are separated according to their m/z or ion mobility.

23. A method according to claim 1, wherein
the ion scheduling device comprises:
an ion separation path along which ions are separated according to their m/z or ion mobility;
a bypass path along which ions are not separated according to their m/z and/or ion mobility; and
a path selection region which selects whether ions travel along the ion separation path or the bypass path.

24. A method according to claim 1, wherein
the ion scheduling device comprises a plurality of ion traps, wherein each ion trap has an associated m/z acceptance window or ion mobility acceptance window, and
the plurality of ion traps output ions in sequence such that the ion scheduling device outputs ions to the mass analyser according to the m/z or ion mobility of the ions.

25-26. (canceled)
